(19) United States
(12) Patent Application Publication
(10) Pub. No.: US 2012/0029880 A1
(43) Pub. Date: Feb. 2, 2012

(54) METHOD AND SYSTEM FOR DETERMINING A SPECTRAL VECTOR FROM MEASURED ELECTRO-MAGNETIC-RADIAION INTENSITIES

(76) Inventors: Michal Aharon, Haifa (IL); Doron Shaked, Haifa (IL); Renato Keshet, Haifa (IL)

(21) Appl. No.: 13/147,363

(22) PCT Filed: Jan. 30, 2009
(86) PCT No.: PCT/US09/00622

§ 371 Date: Sep. 28, 2011

(51) Int. Cl. G06F 15/00

(52) U.S. Cl. 702/189

(57) ABSTRACT

Embodiments of the present invention are directed to determining the spectral vector of electromagnetic radiation reflected from, transmitted through, or emitted from a sample using a set of n intensity measurements. In general, the spectral vector has a dimension k that is greater than the number of measured intensities n. However, in many cases, the physical and chemical constraints of a system, when properly identified and modeled, effectively reduce the number of unknowns, generally the k components of the spectral vector, to an extent that allows for the spectral vector to be characterized from a relatively small number n of measured intensities.

### TECHNICAL FIELD

The present invention is related to the analysis and characterization of electromagnetic radiation and, in particular, to a method and system for determining a spectral vector based on a discrete set of measured electromagnetic-radiation intensities, each corresponding to a different range of frequencies or wavelengths.

### BACKGROUND OF THE INVENTION

The characterization and analysis of electromagnetic radiation is a fundamental scientific tool used in a wide variety of different fields and disciplines, including chemistry, materials science, physics, astronomy, medical diagnosis, and many other fields and disciplines. A known electromagnetic-radiation source is generally used to illuminate a sample or surface, and electromagnetic radiation reflected from the sample or surface, or transmitted through the sample or surface, is compared to the source electromagnetic radiation in order to determine chemical and physical properties of the sample. Spectrometers and spectrophotometers are employed, for example, in chemistry to determine the identities and concentrations of solutes in solution.

There are many different problem domains in which it would be useful to be able to determine the spectrum of electromagnetic radiation reflected from, transmitted through, or emitted from various types of objects and solutions in order to facilitate various automated processes and procedures.

Frequently, these problem domains can accommodate only relatively small and inexpensive devices for spectrum capture and analysis. Unfortunately, the highly accurate, but complex and expensive spectrometers, spectrophotometers, and spectrum analyzers used in various branches of chemistry, physics, and materials science cannot be used in these problem domains, because of their cost, complexity, and often manual or semi-manual operational interfaces. Less precise methods that employ filters may be used to estimate the spectrum of reflected, transmitted, or emitted light, but, in many cases, these methods cannot provide accurate and high-resolution estimates of spectra that would be useful in various problem domains. Thus, researchers, developers, and device manufacturers continue to seek inexpensive and relatively accurate and high-resolution methods and systems for characterizing the spectra of electromagnetic radiation that can be incorporated into various automated processes and devices and applied to a variety of different problem domains.

### BRIEF DESCRIPTION OF THE DRAWINGS

FIG. 1 illustrates perception of light reflected from the surface of a color-printed document.

FIG. 2 illustrates various types of interactions between incident electromagnetic radiation and a surface or substance onto which the incident electromagnetic radiation impinges.

FIG. 3 shows exemplary spectra for two different samples from which light is reflected, through which light is transmitted, or from which light is emitted.

FIG. 4 illustrates a discrete approximation of a continuous spectrum.

FIG. 5 illustrates several different color models.

FIG. 6 illustrates a distance metric in color space.

FIG. 7 illustrates a conceptual model of the devices that collect intensity measurements that are used for spectral-vector determination according to embodiments of the present invention.

FIG. 8 illustrates the concept of a surface or manifold within a space.

FIG. 9 illustrates monochrome half-tone printing.

FIG. 10 provides a control-flow diagram that illustrates one embodiment of the present invention.

FIG. 11 illustrates, for a single dimension within an m-indexed cellular Neugebauer model, how an indexed p_{d} vector is chosen from among a set of related indexed p_{d} vectors for inclusion in the m-indexed cellular-Neugebauer-model equivalent of the P_{D} matrix, P_{D}_{^{m}}.

FIG. 12 illustrates, for two dimension within an m-indexed cellular Neugebauer model, how an indexed p_{d-index} vector is chosen from among a set of related indexed p_{d-index} vectors for inclusion in the m-indexed cellular-Neugebauer-model equivalent of the basis-vector matrix P_{D} matrix, P_{D}_{^{m}}.

FIGS. 13-18 provide control-flow diagrams for a second embodiment of the present invention, which employs an m-indexed cellular Neugebauer model rather than the single-indexed Neugebauer model employed in the initial embodiment of the present invention, illustrated in FIG. 10.

FIGS. 19A-B provide pseudocode for the first Neugebauer-model-based optimization method, discussed with reference to FIG. 10, and the m-indexed cellular-Neugebauer-model-based optimization method, discussed with reference to FIGS. 13-18, both representing embodiments of the present invention.

FIG. 20 shows the response for three filters that are available inline on the Indigo press.

FIGS. 21A-B provide results from the test analysis according to an embodiment of the present invention.

FIG. 22 shows improved accuracy obtained by the m-indexed cellular-Neugebauer-model-based method according to an embodiment of the present invention.

FIGS. 23A-B provide results from the m-indexed cellular-Neugebauer-model-based method, according to an embodiment of the present invention, in similar fashion to FIGS. 21A-B.

### DETAILED DESCRIPTION OF THE INVENTION

Embodiments of the present invention are directed to determining a spectral vector that represents the intensity-versus-frequency or intensity-versus-wavelength spectrum for sampled electromagnetic radiation. In general, the electromagnetic radiation is reflected from a sample surface, transmitted through the sample, or emitted from the sample. Intensities within a number n of frequency or wavelength ranges are measured by any of various intensity-measurement devices and procedures. Embodiments of the present invention are particularly directed to problem domains in which the number of measured intensities n is less than the dimension of the spectral vector k. In these cases, additional constraints are derived from physical and chemical characteristics of the sample so that the spectral vector can be reliably estimated from the n intensity measurements.

Embodiments of the present invention are discussed, below, in the context of determining the spectral vector for visible light reflected from the surface of a color-printed area, or patch, on the surface of a color-printed page. In particular, for color-printer applications, it may be useful to incorporate a small, accurate, and low-cost filter-based intensity-measuring device in order to determine the spectral vector for light reflected from color-printed pages, so that printing quality and fidelity can be monitored on a continuous basis and so that ink combinations and ink coverages may be adjusted for different types and colors of paper and other printing substrates. However, embodiments of the present invention may find application in a wide variety of additional problem domains, including automated chemical-solution and surface analysis, diagnostic-analysis systems, surface-analysis system, optical systems, including automated telescopes, cameras, video recorders, and other optical systems, a quality-control-monitoring system; and environmental monitoring systems, to name a few.

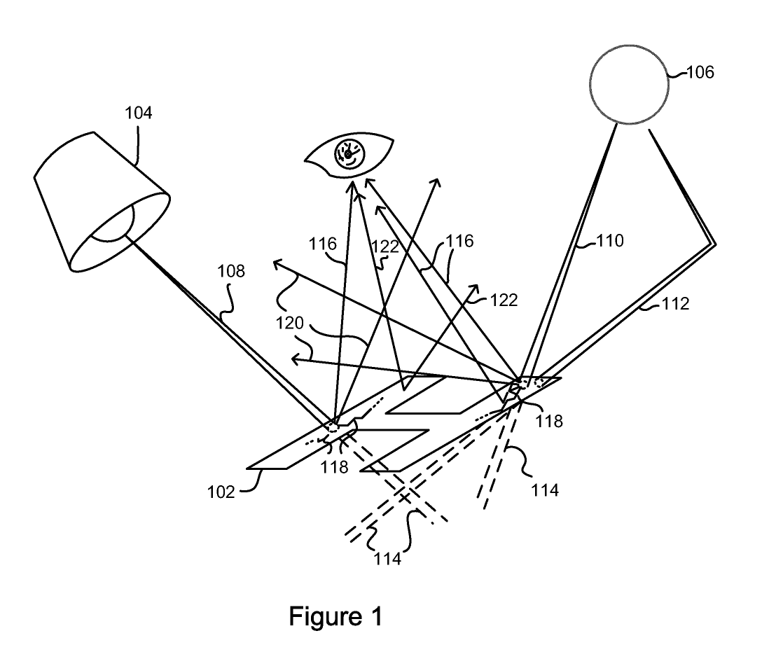

FIG. 1 illustrates perception of light reflected from the surface of a color-printed document. In particular, FIG. 1 shows a printed letter “H” 102 that is illuminated by an incandescent light 104 as well as by sunlight 106. The lamplight and sunlight falls directly onto the printed letter 108 and 110 and is also reflected from other objects 112. When the source illumination falls onto the printed letter, a portion of the impinging source illumination may be transmitted through the letter 114, a portion of the impinging illumination may be reflected from the surface of the letter towards the eye of an observer 116, a portion of the impinging illumination may be absorbed by the inks and substrate, a portion of the impinging illumination may be scattered within the substrate, such as a paper page 118, a portion of the impinging illumination may be reflected or scattered in directions other than towards the eye of an observer 120, and a portion of the impinging illumination may be absorbed within the inks or substrate and subsequently re-emitted 122. The color and intensity of the printed letter “H” perceived by an observer may depend on the type, positions, and orientations of the illumination sources, on the chemical content of the printed character and the chemical and physical properties of the underlying substrate, and on the orientation of the printed character and underlying substrate with respect to the human observer. Moreover, the perceived color and intensity may vary, over time, with variations in source illumination and source-illumination positions and orientations, printed-page orientation, and chemical and physical properties of printed extant images and underlying substrate.

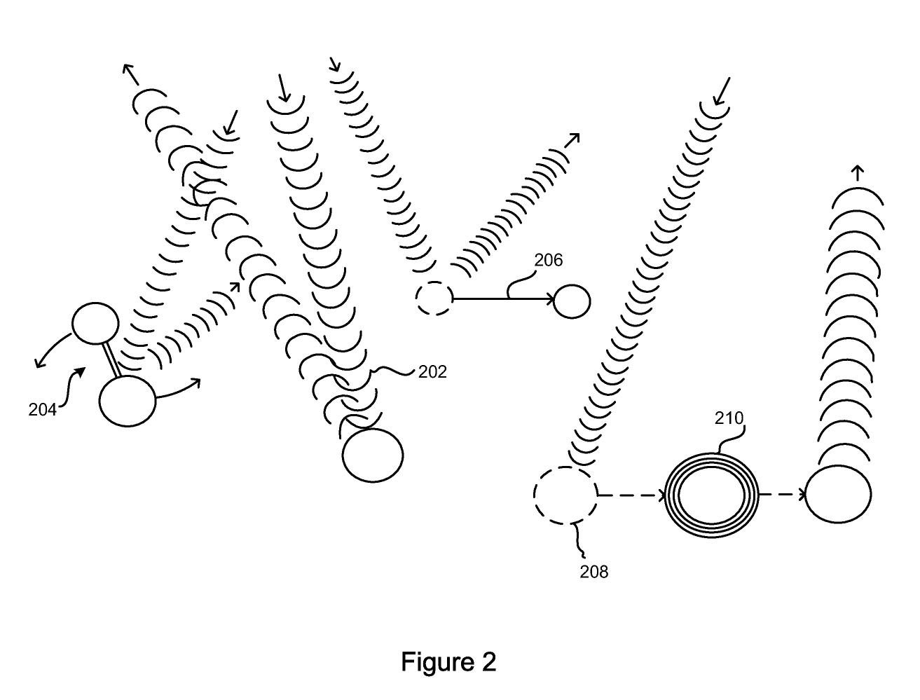

FIG. 2 illustrates various types of interactions between incident electromagnetic radiation and a surface or substance onto which the incident electromagnetic radiation impinges. In certain cases, the electromagnetic radiation may be reflected, without appreciable change in the intensity or spectrum of the electromagnetic radiation, from the surface or substance 202. In other cases, the impinging electromagnetic radiation may result in increased rotational 204 or translational 206 velocities of molecules of a surface or substance onto which the electromagnetic radiation impinges. The electromagnetic radiation may be entirely converted into molecular motion, and therefore heat, or may be partially absorbed by the surface or substance, and partially reflected from the surface or substance. In these cases, the spectrum of the impinging electromagnetic radiation differs from the spectrum of the reflected electromagnetic radiation. Intensities of those frequencies absorbed by the surface or substance and transformed into heat are smaller, in the reflected radiation, than in the incident radiation. In other cases, radiation of particular frequency within the incident electromagnetic radiation may be absorbed by molecules of the substance or surface 208 to produce excited-state molecules 210. Excited-state molecules may subsequently fall back to ground state, re-emitting electromagnetic radiation of a lower frequency or longer wavelength. Fluorescent emission occurs over relatively short times, and phosphorescent emission occurs over relatively long periods of time. The spectrum of electromagnetic radiation that is reflected from a surface or transmitted through a substance may differ markedly from that of the incident electromagnetic radiation, and the spectra may be quite complex, time-varying functions of intensity with respect to wavelength or frequency.

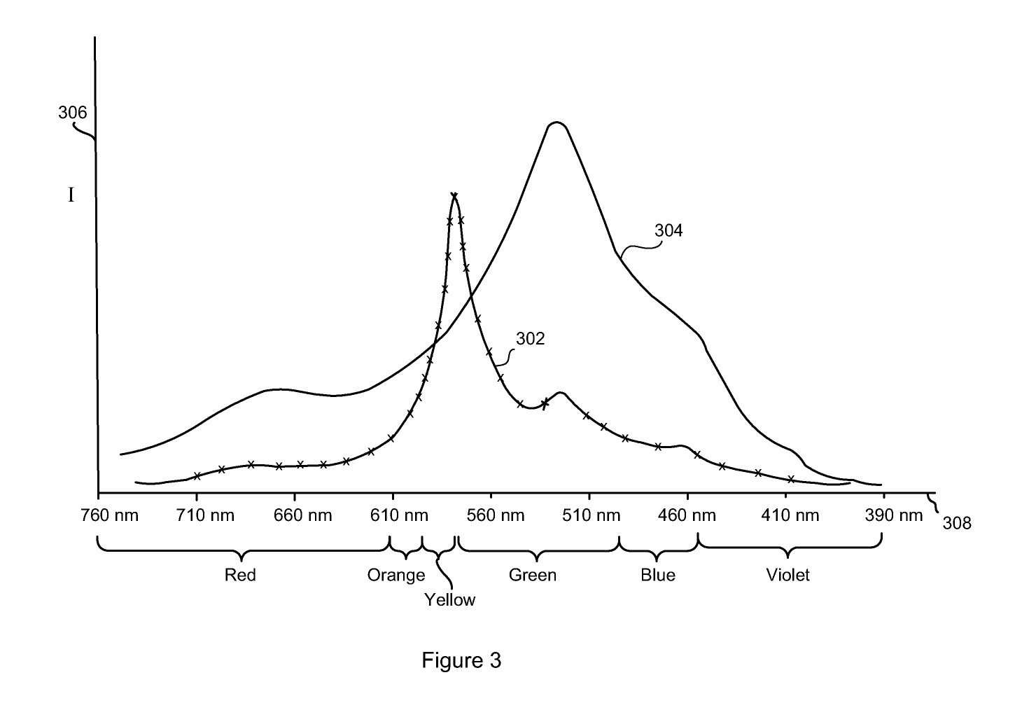

FIG. 3 shows exemplary spectra for two different samples from which light is reflected, through which light is transmitted, or from which light is emitted. Each of the two spectra 302 and 304 are shown as continuous functions of intensity, plotted with respect to the vertical axis 306, and wavelength, plotted with respect to the horizontal axis 308. Wavelength is inversely related to frequency. A spectrum may be plotted with respect either to wavelength or frequency. In FIG. 3, the frequency increases from left to right along the horizontal axis 308, while the wavelength decreases from left to right. In general, the intensity varies significantly with respect to wavelength or frequency, due to variations in intensity with wavelength or frequency in the incident light as well as to partial absorption of light by the sample. It is partial absorption of light that produces the perception of color. For example, electromagnetic radiation characterized by spectrum 302 would appear yellowish, while electromagnetic radiation characterized by the spectrum 304 would appear greenish, due to absorption by the sample of various frequency or wavelength ranges. In certain cases, spectra may feature very narrow and sharp peaks, or bands, as, for example, visible light observed at a fixed angle with respect to a diffraction grading. In other cases, such as a non-homogeneous sample illuminated by various different types of light sources, the spectrum may feature relatively broad peaks.

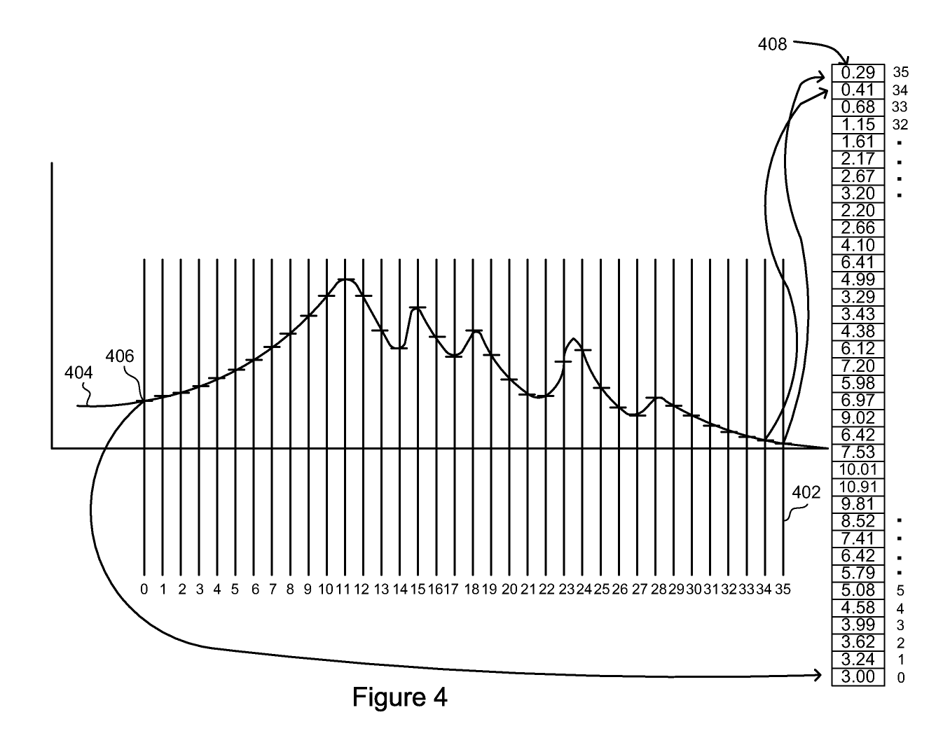

Various types of measuring devices may produce continuous intensity-versus-wavelength measurements, resulting in spectra such as those shown in FIG. 3. In other cases, intensities may be measured at discrete, narrow frequency or wavelength ranges, leading to a discrete approximation of a continuous spectrum. FIG. 4 illustrates a discrete approximation of a continuous spectrum. In FIG. 4, the intensities of light reflected from, or transmitted through, a sample are measured at 36 different frequencies or wavelengths, represented by vertical lines, such as vertical line 402. The intersection of these vertical lines with the continuous spectrum 404, such as at intersection point 406, represent discrete intensity measurements. These discrete intensity measurements may be collected into a spectral vector 408 of dimension k, where k is equal to the number of discrete intensity measurements across the frequency or wavelength range that is sampled. Thus, the spectral vector 408 is a k-dimensional vector within R^{k}. In FIG. 4, the components within the spectral vector 408 are arranged in sequential order according to wavelength or frequency. In general, an ordering convention is assumed for spectral vectors, and the components are generally sequentially ordered according to wavelength or frequency of the measured intensity values.

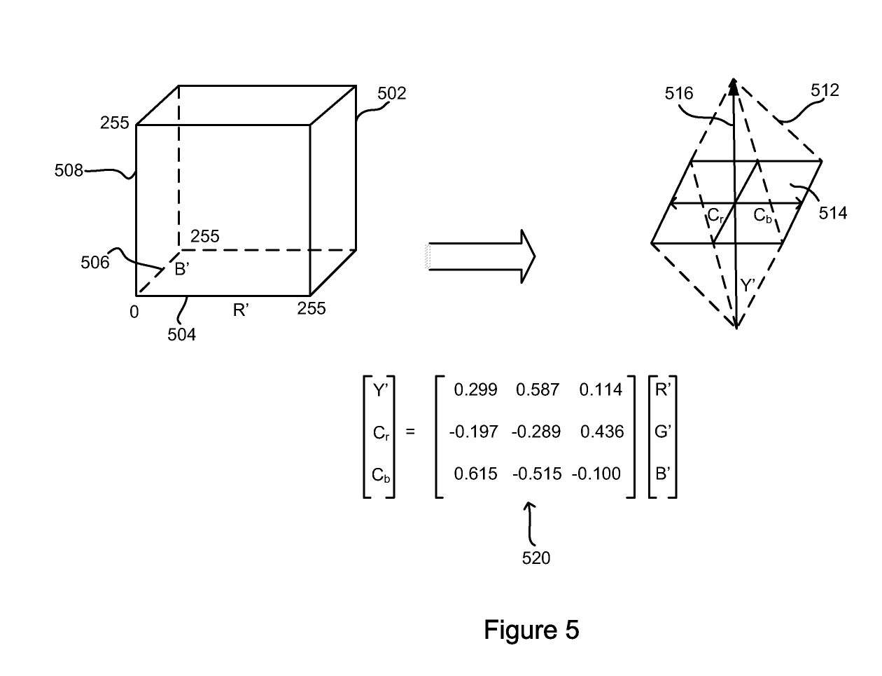

FIG. 5 illustrates several different color models. A first color model 502 is represented by a cube. The volume within the cube is indexed by three orthogonal axes, the R′ axis 204, the B′ axis 206, and the G′ axis 208. The volume of the cube represents all possible color-and-brightness combinations that can be displayed by a display device. The R′, B′, and G′ axes correspond to red, blue, and green components of the colored light emitted by the display device. Although the R′G′B′ color model is relatively easy to understand, particularly in view of the red-emitting-phosphor, green-emitting-phosphor, and blue-emitting-phosphor construction of display units in CRT screens, a variety of related, but different, color models are used for other situation. For example, the Y′CrCb color model, abstractly represented as a bi-pyramidal volume 512 with a central, horizontal plane 514 containing orthogonal Cb and Cr axes and with a long, vertical axis of the bi-pyramid 216 corresponding to the Y′ axis, is often used for video recording, compression, decompression. In this color model, the Cr and Cb axes are color-specifying axes, with the horizontal mid-plane 214 representing all possible hues that can be displayed, and the Y′ axis represents the brightness or intensity at which the hues are displayed. The numeric values that specify the red, blue, and green components in the R′G′B′ color model can be directly transformed to equivalent Y′CrCb values by a simple matrix transformation 520.

For color printing, subtractive colored color models, such as the CMYK color model, are generally employed. The letters “C,” “M,” “Y,” and “K” in the CMYK color model refer to “cyan,” “magenta,” “yellow,” and “key,” with key generally equivalent to “black.” These are the four different ink colors used in four-color printing. The CMYK color model is an example of a color model that lacks a simple transformation to and from the RGB or YCrCb color models, such as the transformation 520 shown in FIG. 5. The CMYK color model represents the range of colors and brightness that can be printed by a color printer as a 4-dimensional volume, each point in the 4-dimensional volume specified by an indication of the amounts of each of the four inks applied to a region of the surface of a substrate.

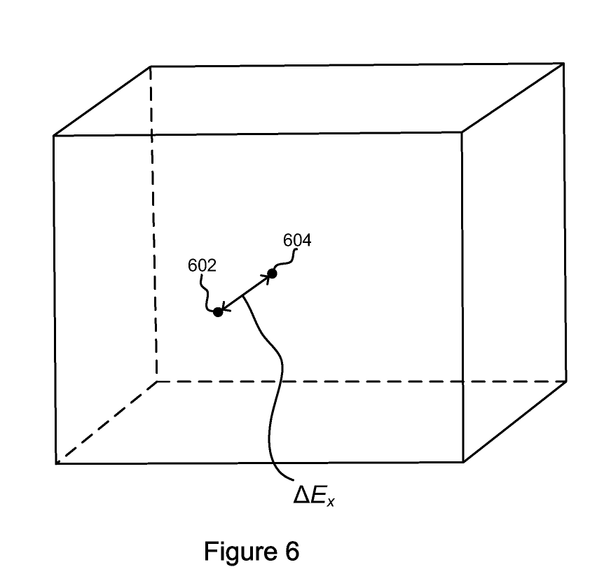

FIG. 6 illustrates a distance metric in color space. As shown in FIG. 6, the distance, in color space, between a first color 602 and a second color 604 may be computed and expressed in terms of various different ΔE metrics. The different ΔE metrics are computed by various different algorithms, and are meant to reflect differences in perceived colors to human users. In general, two different spectral vectors may be mapped to two different points in color space, and a ΔE metric computed from the two points in color space to reflect a perceived color difference between two sources of visible light characterized by the two spectral vectors. Different ΔE metrics may be used as threshold values for determining whether or not two spectral vectors differ above a threshold of perceptibility to a human user.

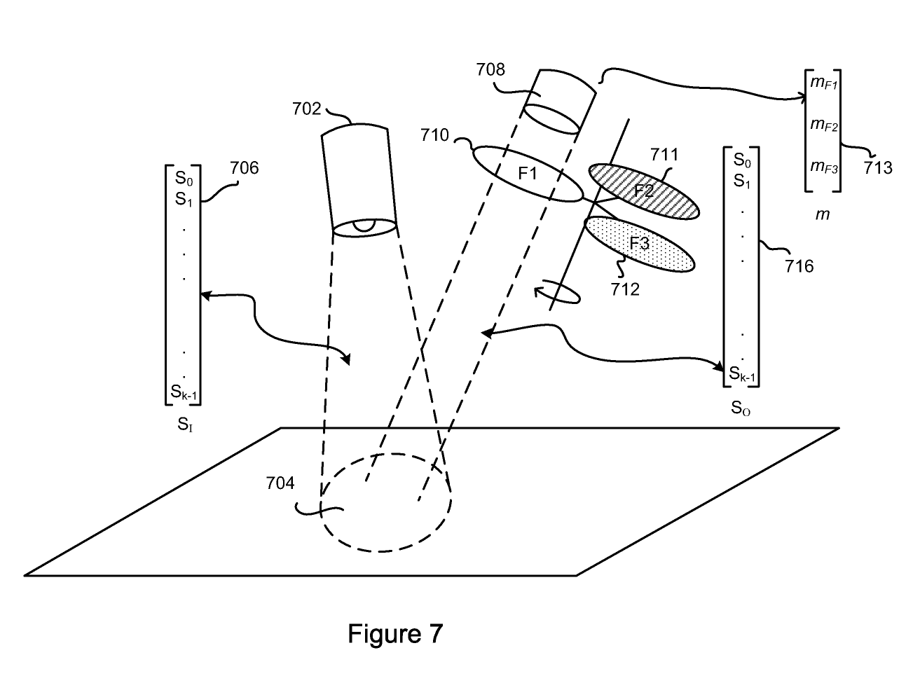

As discussed with reference to FIG. 1, perception of color by a human observer is a complex phenomenon dependant on many different parameters, any of which may be time varying. In a spectral-vector-determination device, as many parameters as possible are controlled, in order to provide for reliable and repeatable intensity measurements and spectral-vector determination. FIG. 7 illustrates a conceptual model of the devices that collect intensity measurements that are used for spectral-vector determination according to embodiments of the present invention. For intensity measurements, a known illumination source 702 is used to illuminate a sample 704. The illumination source 702 emits electromagnetic radiation that can be characterized by a first spectral vector s, 706. The illumination source 702 is assumed to achieve a steady-state, time-invariant emission of electromagnetic radiation. The electromagnetic radiation emitted by the illumination source 702 is reflected by, or transmitted through, a sample, with electromagnetic radiation reflected from, transmitted through, or emitted from the illuminated sample falling on an electronic detector 708. One of a generally modest number n of filters 710-712 is placed in the path of the reflected or transmitted electromagnetic radiation between the sample and detector so that the detector receives only electromagnetic radiation of a narrow range of frequencies or wavelengths when the filters is in place. As shown in FIG. 7, each of the various filters 710-712 can be rotated into position within the electromagnetic-radiation path in order to determine the intensity of a particular narrow wavelength or frequency range of the electromagnetic radiation. Thus, measurement, by the detector 708, of intensities with different filters generates a vector 713 m of n intensity measurements m_{F1}, m_{F2}, m_{F3} in the example shown in FIG. 7, where n is equal to three. The reflected or transmitted electromagnetic radiation is collected, by the detector, over a sufficient period of time to also represent a steady-state, generally time-invariant

The device illustrated in FIG. 7 is only provided as a conceptual illustration. Actual intensity-measurement devices may use semiconductor detectors, the area of which is partitioned below multiple different filters, so that there are no rotating or motor-driven components. In other cases, rather than using physical filters, the detector characteristics may be changed by application of voltages or currents, so that the detector measures intensities for different frequencies or wavelengths when placed into different physical states. In general, the device provides a number n of intensities measured at different wavelengths or frequencies, regardless of implementation.

The problem addressed by embodiments of the present invention is to then determine the spectral vector 716 of the reflected or transmitted electromagnetic radiation based on the vector of measured intensities m. In the following discussion, the spectral vector s has dimension k, so that sεR^{k}. For any given filter F_{X}, a filter-response vector i_{FX} can be found such that the dot product of the spectral vector for the reflected or transmitted electromagnetic radiation, s, with the filter-response vector i_{FX} produces a numeric value corresponding to the intensity measurement m_{FX} obtained by the detector when filter F_{X} is in place, m_{FX}, as indicated by the following expression:

i_{FX}·s=m_{FX}.

For n filters F1, F2, . . . , Fn and n corresponding intensity measurements that together compose a measurement vector m, the n intensity measurements are related to the spectral vector of the reflected or transmitted radiation s by the expression:

$$\begin{matrix}[ \begin{matrix}{i}_{F 1 , 1} & {i}_{F 1 , 2} & {i}_{F 1 , 3} & & {i}_{F 1 , k} \\ {i}_{F 2 , 1} & {i}_{F 2 , 2} & {i}_{F 2 , 3} & & {i}_{F 2 , k} \\ {i}_{F 3 , 1} & {i}_{F 3 , 2} & {I}_{F 3 , 3} & & {i}_{F 3 , k} \\ & & & & \\ {i}_{Fn , 1} & {i}_{Fn , 2} & {i}_{Fn , 3} & & {i}_{Fn , k}\end{matrix} ] \\ L\end{matrix} \begin{matrix}[ \begin{matrix}{s}_{1} \\ {s}_{2} \\ {s}_{3} \\ \\ {s}_{k}\end{matrix} ] \\ s\end{matrix} = \begin{matrix}[ \begin{matrix}{m}_{F 1} \\ {m}_{F 2} \\ {m}_{F 3} \\ \\ {m}_{F , n}\end{matrix} ] \\ m\end{matrix}$$

where L is a filter-response matrix, each row of which is a filter-response vector for a different filter. When the dimension of the spectral vector k is equal to the dimension n of the measurement vector m, when the matrix L and the measurement vector m are known, and when the matrix L is invertible, then the spectral vector s can be uniquely determined:

Ls=m

s=L⁻¹m

In this case, the number of measured values is equal to the number of unknowns, and the problem is exactly determined.

When the number of measured intensities n is greater than the dimension of the spectral vector k, then determination of the spectral vector from the matrix L and the measurement vector m is over-determined. In this case, the spectral vector s can be obtained by a pseudo-inverse or least-squares computation. For example, each measured intensity mᵢ may be considered to be computable, for iε(1,2, . . . ,n), as:

$${m}_{i} = {\sum }_{j = 1}^{k} {L}_{i , j} {s}_{j} or \text{:} {m}_{i} = f ( {L}_{i , s} ) = {\sum }_{j = 1}^{k} {s}_{j} {φ}_{j} ( {L}_{i} )$$

where f and φ are functions. A difference, or residual, can be computed as the difference between the measured intensity mᵢ and the computed intensity, f(Lᵢ,s), as:

rᵢ=mᵢ−f(Lᵢ,s)

The sum of the residuals, R, where R is expressed as:

$$R = {\sum }_{i = 1}^{n} {r}_{i}^{2} ,$$

can then be minimized over the computed spectral vector s in order to determine a spectral vector s that best fits the n intensity measurements.

When n<k, as shown in FIG. 7, then recovery of the spectral vector from matrix L and measurement vector m is not a directly solvable problem. In this case, determination of the spectral vector s is under-determined, or, in other words, there are a greater number of unknowns, the k spectral-vector components, than the number of measurements n. This is the general case to which embodiments of the present invention are applied, and, as discussed above, the relevant case, since a relatively high-resolution, large dimension spectral vector is often desired, but only a limited number of filters are available in small and inexpensive intensity-measurement devices. Embodiments of the present invention are applied in methods and devices constrained by size, power consumption, costs, and the ability to automate operation of the device and incorporate the device into a subcomponent of another device. Embodiments of the present invention are thus directed to solving for s when the solution is undetermined by an intensity-measurement vector m of lower dimension than the desired spectral vector s.

Note that, in the above expressions, the spectral vector for the illumination source (702 in FIG. 7) does not explicitly appear. Instead, the spectral vector for the illumination source is incorporated as multiplicative coefficients of the components of the filter-response vectors. In other words, matrix L is composed of filter-response row vectors specific for a particular intensity-measurement device and method and a specific illumination source.

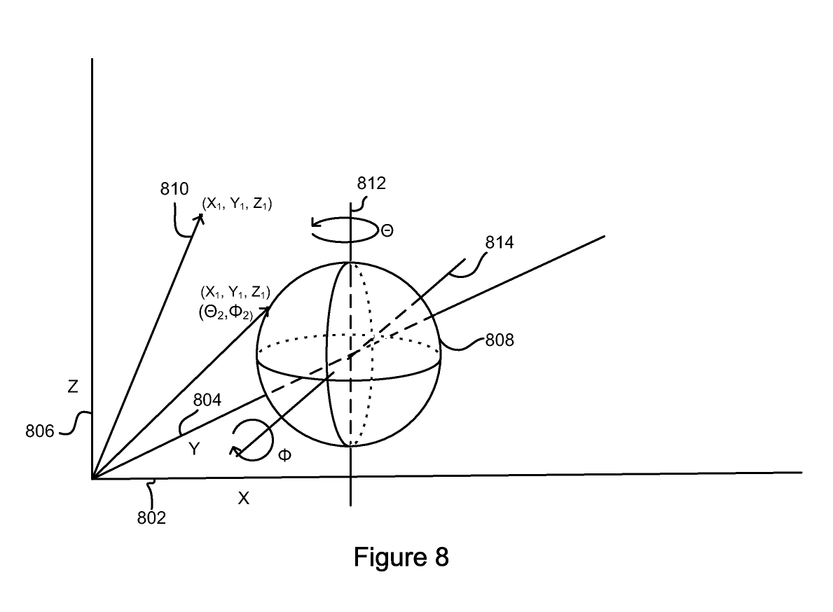

While underdetermined problems, such as computing a k-dimensional spectral vector from n intensity measurements, where n<k, are generally unsolvable, there are various methods for estimating the spectral vector from n intensity measurements when n<k. Certain embodiments of the present invention are based on the observation that only reflected light characterized by spectral vectors within a subspace of R^{k} is generated by various combinations of the four inks used in four-color printing at various fractional coverages. In other words, the spectral vector s for light reflected from printed color patches has four independent parameters and can be expected to fall on a 4-manifold within R^{k}. FIG. 8 illustrates the concept of a surface or manifold within a space. FIG. 8 shows a familiar three-dimensional Cartesian space, defined by orthogonal axes x 802, y 804, and z 806. Within Euclidian three-dimensional space, a sphere 808 is shown. While each point in Euclidian three-dimensional space is generally specified by three coordinates (x, y, z) 810, the points on the surface of the sphere 808 may be alternatively specified by coordinate pairs (Θ,Φ), where Θ represents rotation about a first axis 812 and Φ represents rotation about a second axis 814 orthogonal to the first axis. Thus, knowledge that points lie on the surface of the sphere, and knowledge of the location and size of the sphere, allow for those points on the surface of the sphere to be described using two coordinates rather than three. In analogous fashion, the knowledge that the spectral vectors of dimension k described points on a 4-manifold effectively lower the dimensionality of the expected vectors s with respect to spectral-vector determination. Alternatively, one can consider the constraint of four-color printing as resulting in dependencies between certain of the k dimensions of the spectral vector. Additionally, the black ink, represented by the letter “K” in the CMYK color model, may not be linearly independent from the cyan, magenta, and yellow inks, represented by the letters “C,” “M,” and “Y” in the CMYK color model. The color black is, after all, approximated by a combination of the three inks “C,” “M,” and “Y.” Therefore, the effective dimensionality of the problem may be three, in which case a reasonable estimate of the spectral vector can be obtained from three intensity measurements using three different filters.

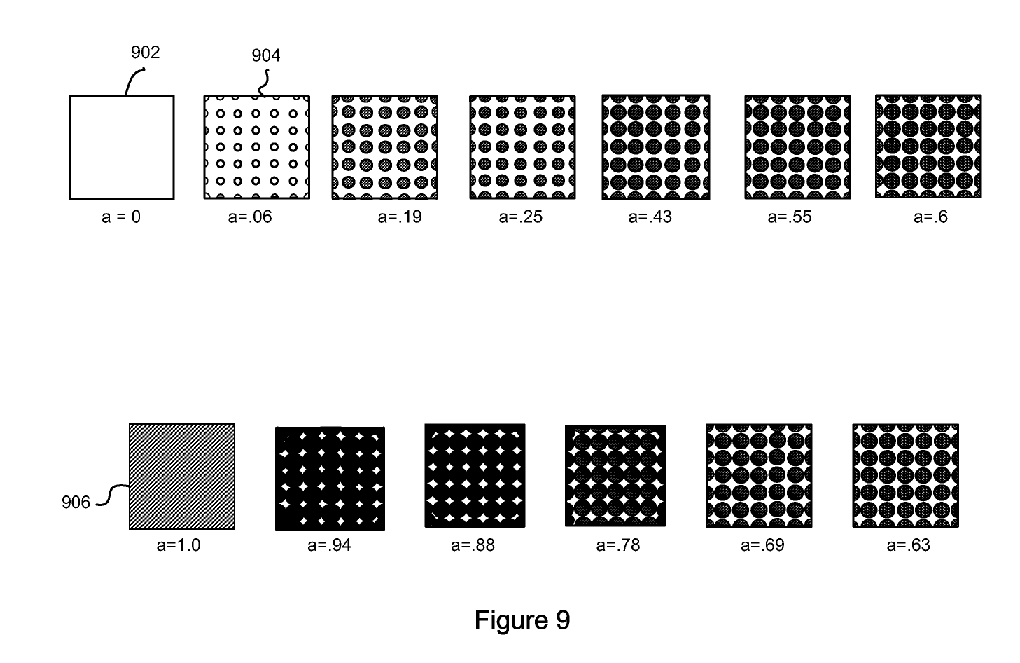

To fully understand the four-color-printing constraints, as employed in certain embodiments of the present invention, an explanation of ink-coverage, or fractional-coverage values, is next provided. FIG. 9 illustrates monochrome half-tone printing. Half-tone printing involves transferring ink in small, regularly sized disks or dots, onto the substrate, with the center of the disks or dots corresponding to a rectilinear grid or other regular grid. The rectilinear grid is fixed, but the radius of the dots can be changed in order to produce more darkly printed areas, or, in other words, to provide greater ink coverage of the area. Assuming that the ink is black, FIG. 9 shows a series of printed areas, or patches, with dots or disks of increasing radius. In general, the dots and disks are smaller than the limits of dimensional perception, so that a viewer perceives the patch or area as a continuous grayscale tone. The patches are significantly magnified, in FIG. 9, with respect to the dimensions of a typical rectilinear grid for half-tone printing. A patch to which no ink is applied 902 appears to have the color of the substrate, and has a fractional coverage a=0.0. In the example shown in FIG. 9, when minimally sized dots or disks are printed in patch 904, the fractional coverage is a=0.06, and the patch is perceived to have a very light gray tone. As the radius of the disks or dots increases, the fractional coverage a correspondingly increases and the patch appears increasingly darker, until a black patch is obtained with fractional coverage a=1.0 (906 in FIG. 9).

In four-color printing, the grids for each of the four ink colors are generally rotated with respect to one another. The color of a printed patch is a function of a CMYK quadruple coordinate, and an expected spectral vector for light reflected from the color patch can be computed from the fractional coverages of the four inks used in printing the patch:

printed color=(a_{c},aₘ,a_{y},aₖ)

where aₓ=functional coverage of ink x

sₑ=f(a_{c},aₘ,a_{y},aₖ)

Various different functions f(a_{c},aₘ,a_{y},aₖ) can be used to estimate a spectral vector for light reflected from a different color patch. One function, or model, is referred to as the Neugebauer model, and is used in certain embodiments of the present invention. The Neugebauer model is expressed as:

$${s}_{e} = N ( {a}_{c} , {a}_{m} , {a}_{y} , {a}_{k} ) = {\sum }_{d ∈ D} {A}_{d} ( {a}_{c} , {a}_{m} , {a}_{y} , {a}_{k} ) \cdot {p}_{d} , where$$

$$D = \{ \begin{matrix}\{ \} , \{ c \} , \{ m \} , \{ y \} , \{ k \} , \{ cm \} , \{ cy \} , \{ ck \} , \{ my \} , \{ mk \} , \\ \{ yk \} , \{ cmy \} , \{ cyk \} , \{ myk \} , \{ cmk \} , \{ cmyk \}\end{matrix} \} ;$$

$${A}_{d} ( {a}_{c} , {a}_{m} , {a}_{y} , {a}_{k} ) = {\prod }_{l ∈ \{ c , m , y , k \}}^{ } g ( d , l , {a}_{l} ) ;$$

$$g ( d , l , {a}_{l} ) = \{ \begin{matrix}when l ∈ d , & {a}_{l} \\ otherwise & 1 - {a}_{l}\end{matrix} \\ {p}_{d} ∈ {R}^{k} ; and$$

p_{d}=experimentally determined s^{k} observed from a patch printed according to (α(c,d),α(m,d),α(y,d),α(k,d))
   where

$$α ( l , d ) = \{ \begin{matrix}when l ∈ d , & {a}_{l} = 1.0 \\ otherwise & {a}_{l} = 0.\end{matrix}$$

Thus, the estimated spectral vector sₑ is computed as the sum of a set of experimentally determined spectral vectors p_{d}, each multiplied by a real coefficient A_{d}. There is an experimentally determined vector p_{d} for each possible combination of inks, including a no-ink combination { }, which are shown above as the set D. The coefficients A_{d} are computed as a product of fractional coverages or combinations of fractional coverages. The determined spectral vector p_{d} is experimentally observed from a patch printed with full coverage, a=1.0, for those inks in the element d of set D. In essence, the spectral vectors p_{d} comprise a basis for all possible expected spectral vectors sₑ.

Were the set of fractional coverages of the four inks used to print patches by four-color printing known exactly, then the problem of determining the spectral vector for light reflected from the patch, using n intensity measurements, could be expressed as:

$$\begin{matrix}min \\ s\end{matrix} {‖ N ( {a}_{c} , {a}_{m} , {a}_{y} , {a}_{k} ) - s ‖}_{2}^{2} s . t . L \cdot s = m$$

However, exact fractional coverages may not, in fact, be determinable due to random and systematic variance in the color-printing apparatus. For this reason, the fractional coverages for the inks as well as the components of the spectral vector are all considered to be unknowns. Therefore, the minimization expressed in either of the two following expressions is undertaken, according to certain embodiments of the present invention, in order to estimate the spectral vector s from n intensity measurements:

$${min}_{s , {a}_{c} , {a}_{m} , {a}_{y} , {a}_{k}} {‖ {S}_{w} ( N ( {a}_{c} , {a}_{m} , {a}_{y} , {a}_{k} ) - s ) ‖}_{2}^{2} s . t . Ls = m$$

$${min}_{s , {a}_{c} , {a}_{m} , {a}_{y} , {a}_{k}} {‖ {S}_{w} ( N ( {a}_{c} , {a}_{m} , {a}_{y} , {a}_{k} ) - s ) ‖}_{2}^{2} + λ {‖ Ls - m ‖}_{2}^{2}$$

$$where$$

$${S}_{w} = [ \begin{matrix}{w}_{1} & 0 & 0 & … & … & … & … \\ 0 & {w}_{2} & 0 & … & … & … & … \\ 0 & 0 & {w}_{3} & … & & & \\ … & … & … & … & … & & \\ … & … & & … & … & … & \\ … & … & & & … & … & 0 \\ … & … & & & & 0 & {w}_{k}\end{matrix} ]$$

In the second of the above two minimization problems, the term λ∥Ls−m∥₂² allows for variation in the measured intensity values m. When the coefficient λ, is very large, the second minimization problem is equivalent to the first minimization problem, since a large coefficient λ, forces Ls to equal m. The matrix S_{w} is a weight matrix used to weight the different components of the expected spectral vector, to account for the fact that the Neugebauer model may have varying accuracy for different components. When weighting is not desired, the identity matrix can be substituted for S_{w}. The notation ∥s_{w}(N(a_{c}, aₘ, a_{y}, aₖ)−s)∥₂² is the square of the Euclidean distance metric, or length, of the vector difference between the expected spectral vector sₑ=S_{w}N(a_{c}, aₘ, a_{y}, aₖ) and the determined or computed spectral vector s.

The minimization problem can be alternatively expressed with a matrix equation. First, the basis-vector matrix P_{D} is defined as a matrix having vectors p_{d} as columns:

P_{D}=[[P_{w}][P_{c}][Pₘ][P_{y}][Pₖ][P_{cm}][P_{cy}][P_{ck}][P_{my}][Pₘₖ][P_{yk}][P_{cmy}][P_{cyk}][P_{cmk}][P_{myk}][P_{cmyk}]]

The function x(a_{c}, aₘ, a_{y}, aₖ) returns a column vector as follows:

x(a_{c},aₘ,a_{y},aₖ)=[1,a_{c},aₘ,a_{y},aₖ,a_{c}aₘ,a_{c}a_{y},a_{c}aₖ,aₘa_{y},aₘaₖ,a_{y}aₖ,a_{c}aₘa_{y}, a_{c}a_{y}aₖ, a_{c}aₘaₖ, aₘa_{y}aₖ, a_{c}aₘa_{y}aₖ]^{T}

The matrix B is defined as:

$$B = [ \begin{matrix}1 & - 1 & - 1 & - 1 & - 1 & 1 & 1 & 1 & 1 & 1 & 1 & - 1 & - 1 & - 1 & - 1 & 1 \\ 0 & 1 & 0 & 0 & 0 & - 1 & - 1 & - 1 & 0 & 0 & 0 & 1 & 1 & 1 & 0 & - 1 \\ 0 & 0 & 1 & 0 & 0 & - 1 & 0 & 0 & - 1 & - 1 & 0 & 1 & 0 & 1 & 1 & - 1 \\ 0 & 0 & 0 & 1 & 0 & 0 & - 1 & 0 & - 1 & 0 & - 1 & 1 & 1 & 0 & 1 & - 1 \\ 0 & 0 & 0 & 0 & 1 & 0 & 0 & - 1 & 0 & - 1 & - 1 & 0 & 1 & 1 & 1 & - 1 \\ 0 & 0 & 0 & 0 & 0 & 1 & 0 & 0 & 0 & 0 & 0 & - 1 & 0 & - 1 & 0 & 1 \\ 0 & 0 & 0 & 0 & 0 & 0 & 1 & 0 & 0 & 0 & 0 & - 1 & - 1 & 0 & 0 & 1 \\ 0 & 0 & 0 & 0 & 0 & 0 & 0 & 1 & 0 & 0 & 0 & 0 & - 1 & - 1 & 0 & 1 \\ 0 & 0 & 0 & 0 & 0 & 0 & 0 & 0 & 1 & 0 & 0 & - 1 & 0 & 0 & - 1 & 1 \\ 0 & 0 & 0 & 0 & 0 & 0 & 0 & 0 & 0 & 1 & 0 & 0 & 0 & - 1 & - 1 & 1 \\ 0 & 0 & 0 & 0 & 0 & 0 & 0 & 0 & 0 & 0 & 1 & 0 & - 1 & 0 & - 1 & 1 \\ 0 & 0 & 0 & 0 & 0 & 0 & 0 & 0 & 0 & 0 & 0 & 1 & 0 & 0 & 0 & - 1 \\ 0 & 0 & 0 & 0 & 0 & 0 & 0 & 0 & 0 & 0 & 0 & 0 & 1 & 0 & 0 & - 1 \\ 0 & 0 & 0 & 0 & 0 & 0 & 0 & 0 & 0 & 0 & 0 & 0 & 0 & 1 & 0 & - 1 \\ 0 & 0 & 0 & 0 & 0 & 0 & 0 & 0 & 0 & 0 & 0 & 0 & 0 & 0 & 1 & - 1 \\ 0 & 0 & 0 & 0 & 0 & 0 & 0 & 0 & 0 & 0 & 0 & 0 & 0 & 0 & 0 & 1\end{matrix} ]$$

With the above definitions for P_{D}, x(a_{c},aₘ,a_{y},aₖ), and B, the second minimization problem can then be recast as a function F(s,a_{c},aₘ,a_{y},aₖ):

F(s,a_{c},aₘ,a_{y},aₖ)=∥S_{w}(P_{D}Bx(a_{c},aₘ,a_{y},aₖ)−s)∥₂²+λ∥Ls−m∥₂²

which is minimized with respect to s, a_{c}, aₘ, a_{y}, and aₖ:

$$\begin{matrix}min \\ s , {a}_{c} , {a}_{m} , {a}_{y} , {a}_{k}\end{matrix} F ( s , {a}_{c} , {a}_{m} , {a}_{y} , {a}_{k} )$$

The partial differential of the function F with respect to s is then:

$$\frac{\partial F}{\partial s} = - 2 {S}_{w}^{T} ( {S}_{w} {P}_{D} Bx ( {a}_{c} , {a}_{m} , {a}_{y} , {a}_{k} ) - {S}_{w} s ) + 2 λ {L}^{T} ( Ls - m )$$

Note that S_{w} and L are both rectangular matrices, in the case that the number of measured intensities n is less than the dimension k of the spectral vector s, so that these matrices are multiplied by their transposes in the above partial differential equation. Setting

$$\frac{\partial F}{\partial s}$$

to zero, and solving for s produces a value for s that represents a local or global extremum. In the current case, the extremum represents a local or global minimum, and thus a first approach to optimization of the function F(s,a_{c},aₘ,a_{y},aₖ) with respect to s can be expressed as:

s=(λL^{T}L+S_{W}^{T}S_{W})⁻¹·(S_{W}^{T}S_{W}P_{D}Bx(a_{c},aₘ,a_{y},aₖ)+λL^{T}m)

The partial differential of F with respect to any of the fractional coverages z, where zε{a_{c},aₘ,a_{y},aₖ} can be expressed as:

$$\frac{\partial F}{\partial x} = - 2 {B}^{T} {P}_{D}^{T} {S}_{w}^{T} ( {S}_{w} {P}_{D} Bx ( {a}_{c} , {a}_{m} , {a}_{y} , {a}_{k} ) - {S}_{w} s )$$

Using a steepest-descent approach, the function F can be minimized with respect to a_{c},aₘ,a_{y},aₖ by recomputing the vector x by successive iterations in which an adjusted vector x′ is computed as:

x′=x−εB^{T}P_{D}^{T}S_{w}^{T}S_{w}(P_{D}Bx−s)

and then a next value for x, x*, is computed by the function x( ) with parameters obtained from a projection of x′:

x*←x(x′_{[2]},x′_{[3]},x′_{[4]},x′_{[5]})

In a family of embodiments of the present invention, the spectral vector s and fractional ink coverages a_{c}, aₘ, a_{y}, and aₖ are determined by repeated, successive higher-level iterations in which s is first optimized and then the vector x is iteratively optimized.

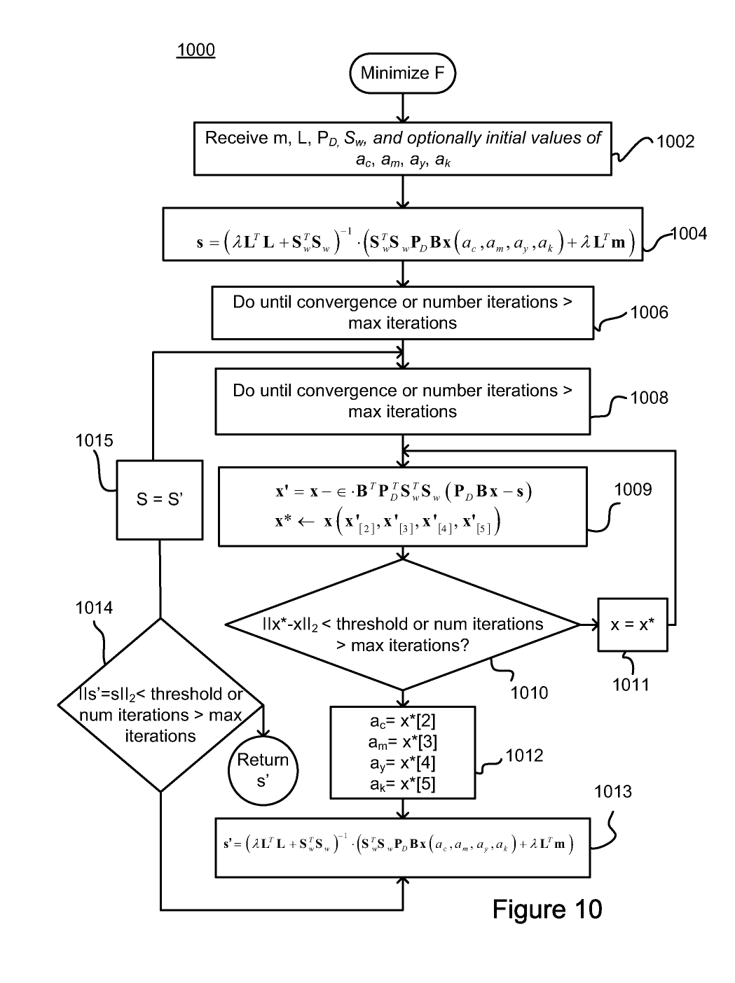

FIG. 10 provides a control-flow diagram that illustrates one embodiment of the present invention. The control-flow diagram 1000 shown in FIG. 10 illustrates an iterative computational method that is, due to the computational complexity of the method, necessarily carried out on an electronic computer or other electronic computational processing entity. In general, the method is carried out in support of a spectral-vector-determining device that is included, as a subcomponent, in another device. However, small, highly accurate, standalone electromagnetic-radiation analysis devices may also employ method embodiments of the present invention. Examples include spectral-vector-determination components of a color printer that are used to continuously monitor output quality and modify ink-coverage parameters in order to adjust printing to different colors and types and substrates. The method shown in FIG. 10 is carried out, upon completion of a sampling of a reflected, transmitted, or emitted electromagnetic radiation, in order to determine the spectral vector for the reflected, transmitted, or emitted electromagnetic radiation.

In a first step, the measurement vector m, the filter-response matrix L, the basis-vector matrix P_{D}, the normalization vector S_{w}, and, optionally, initial values of a_{c}, aₘ, a_{y}, and aₖ are received, in step 1002. The initial values of a_{c}, aₘ, a_{y}, and aₖ may be, for example, provided by a color printer, since the color printer will have printed the patch for area that is subsequently analyzed in order to determine the spectral vector. If these values are not supplied, then the values may be set to default values of 1.0 or some other initial default value. Next, in step 1004, an initial estimate of the spectral vector s is computed by setting the partial differential of the function F with respect to s to 0, as discussed above. In an outer iterative loop, comprising steps 1006 and steps 1013-1015, successive estimations of s are computed, by setting the partial differential of the function F to 0 and solving for a next estimation of s, s′, in step 1013, following which s′ is tested for convergence, in step 1014. If the difference between the next computed value of s, s′, and the previously computed value of s is less than a threshold value, as determined in step 1014, then the value s′ computed in step 1013 is returned. Otherwise, s is set to s′ in step 1015 and the outer loop repeated. In step 1014, the outer loop is terminated in the case that the number of iterations of the outer loop has exceeded some maximum number of iterations. In an inner iterative loop, comprising steps 1008-1012, the vector x is successively recomputed, by a steepest-descent method in which ∂F/∂x is iteratively recomputed and used to steer x towards a value that minimizes the function F. As discussed above, in step 1009, the next value of vector x, x*, differs from the previous value of x by less than some threshold amount, or when a maximum number of iterations for the inner loop is exceeded, as determined in step 1010, then the optimized values for a_{c}, aₘ, a_{y}, and aₖ are extracted from the most recently computed value for x, x*, in step 1012.

The method that represents one embodiment of the present invention, illustrated in FIG. 10 and discussed above, is efficient and computationally tractable, but is not guaranteed to producing a global minimum for F and the computed spectral vector values do not necessarily converge. A cost function can be applied, in the inner loop comprising steps 1008-1012, to detect generation of a next vector x* less optimal than the previously computed vector x, in order to prevent oscillation and to force convergence. An additional problem with this first embodiment of the present invention, in certain applications, is that K in the CMYK color model is not totally independent of C, M, and Y, as discussed above. This lack of independence may result in a variety of different local minima for the function F which yield similar spectral vectors, but which are associated with different fractional coverages for the four inks. In certain problem domains, the Neugebauer model is not sufficiently accurate.

A second approach to determining the spectral vector for reflected, transmitted, or emitted electromagnetic radiation, is similar to the first approach, with the exception that a cellular Neugebauer model is used for spectral-vector estimation, rather than the Neugebauer model. This approach employs families of related p_{d-index} vectors for each p_{d} vector employed in the first approach. In the first approach, the set D has a cardinality |D| that can be computed, by simple combinatorics, as:

$$\vert D \vert = ( \begin{matrix}4 \\ 0\end{matrix} ) + ( \begin{matrix}4 \\ 1\end{matrix} ) + ( \begin{matrix}4 \\ 2\end{matrix} ) + ( \begin{matrix}4 \\ 3\end{matrix} ) + ( \begin{matrix}4 \\ 4\end{matrix} ) = 1 + 4 + 6 + 4 + 1 = 16$$

As discussed above, for each subset element d of D, each of the specified inks are printed at full coverage, or a=1.0, in the patch that is analyzed to produce p_{d}. In the cellular Neugebauer model, there are a family of related indexed p_{d-index} vectors for each p_{d} vector in the Neugebauer model, with the family of indexed p_{d-index} vectors generated by coverage of any of the inks in the subset d at m+1 different fractional coverages: {a=0, a=1/m, a=2/m, . . . , a=m/m=1}. The previously described Neugebauer model is thus based on the set D, elements d of which are different combinations of the four inks C, M, Y, and K, while the cellular Neugebauer model is based on a set Er constructed from all possible combinations of the four inks, each ink further partitioned into a series of coverages. The elements are specified as combinations of indexed ink characters, where the index corresponds to the numerator in the series of m+1 fractional coverages. In other words:

each d of D^{m} is a 1-tuple, 2-tuple, 3-tuple, or 4-tuple selected from

{{c₀,c₁, . . . ,cₘ},{m₀,m₁, . . . ,mₘ},{y₀,y₁, . . . ,yₘ},{kₒk₁, . . . ,kₘ}}

The cardinality of the set D^{m} is, by simple combinatorics:

|D^{m}|=1+4(m)+6(m²)+4(m³)+m⁴

As an example:

$${D}^{2} = \{ \begin{matrix}\{ \} , \{ {c}_{1} \} , \{ {c}_{2} \} , \{ {m}_{1} \} , \{ {m}_{2} \} , \{ {y}_{1} \} , \{ {y}_{2} \} , \{ {k}_{1} \} , \{ {k}_{2} \} , \\ \{ {c}_{1} {m}_{1} \} , \{ {c}_{1} {m}_{2} \} , \{ {c}_{2} {m}_{1} \} , \{ {c}_{2} {m}_{2} \} , \{ {c}_{1} {y}_{1} \} , \{ {c}_{1} {y}_{2} \} , \{ {c}_{2} {y}_{1} \} , \{ {c}_{2} {y}_{2} \} , \\ \{ {c}_{1} {k}_{1} \} , \{ {c}_{1} {k}_{2 } \} , \{ {c}_{2} {k}_{1} \} , \{ {c}_{2} {k}_{2} \} , \{ {m}_{1} {y}_{1} \} , \{ {m}_{1} {y}_{2} \} , \{ {m}_{2} {y}_{1} \} , \{ {m}_{2} {y}_{2} \} , \\ \{ {m}_{1} {k}_{1} \} , \{ {m}_{1} {k}_{2} \} , \{ {m}_{2} {k}_{1} \} , \{ {m}_{2} {k}_{2} \} , \{ {y}_{1} {k}_{1} \} , \{ {y}_{1} {k}_{2} \} , \{ {y}_{2} {k}_{1} \} , \{ {y}_{2} {k}_{2} \} , \\ \begin{matrix}\{ {c}_{1} {m}_{1} {y}_{1} \} , \{ {c}_{1} {m}_{2} {y}_{1} \} , \{ {c}_{1} {m}_{1} {y}_{2} \} , \{ {c}_{1} {m}_{2} {y}_{2} \} , \\ \{ {c}_{2} {m}_{1} {y}_{1} \} , \{ {c}_{2} {m}_{2} {y}_{1} \} , \{ {c}_{2} {m}_{1} {y}_{2} \} , \{ {c}_{2} {m}_{2} {y}_{2} \} ,\end{matrix} \\ \begin{matrix}\{ {c}_{1} {y}_{1} {k}_{1} \} , \{ {c}_{1} {y}_{2} {k}_{1} \} , \{ {c}_{1} {y}_{1} {k}_{2} \} , \{ {c}_{1} {y}_{2} {k}_{2} \} , \\ \{ {c}_{2} {y}_{1} {k}_{1} \} , \{ {c}_{2} {y}_{2} {k}_{1} \} , \{ {c}_{2} {y}_{1} {k}_{2} \} , \{ {c}_{2} {y}_{2} {k}_{2} \} ,\end{matrix} \\ \begin{matrix}\{ {m}_{1} {y}_{1} {k}_{1} \} , \{ {m}_{1} {y}_{2} {k}_{1} \} , \{ {m}_{1} {y}_{1} {k}_{2} \} , \{ {m}_{1} {y}_{2} {k}_{2} \} , \\ \{ {m}_{2} {y}_{1} {k}_{1} \} , \{ {m}_{2} {y}_{2} {k}_{1} \} , \{ {m}_{2} {y}_{1} {k}_{2} \} , \{ {m}_{2} {y}_{2} {k}_{2} \} ,\end{matrix} \\ \begin{matrix}\{ {c}_{1} {m}_{1} {k}_{1} \} , \{ {c}_{1} {m}_{2} {k}_{1} \} , \{ {c}_{1} {m}_{1} {k}_{2} \} , \{ {c}_{1} {m}_{2} {k}_{2} \} , \\ \{ {c}_{2} {m}_{1} {k}_{1} \} , \{ {c}_{2} {m}_{2} {k}_{1} \} , \{ {c}_{2} {m}_{1} {k}_{2} \} , \{ {c}_{2} {m}_{2} {k}_{2} \} ,\end{matrix} \\ \begin{matrix}\{ {c}_{1} {m}_{1} {y}_{1} {k}_{1} \} , \{ {c}_{1} {m}_{1} {y}_{1} {k}_{2} \} , \{ {c}_{1} {m}_{1} {y}_{2} {k}_{1} \} , \{ {c}_{1} {m}_{1} {y}_{2} {k}_{2} \} , \\ \{ {c}_{1} {m}_{2} {y}_{1} {k}_{1} \} , \{ {c}_{1} {m}_{2} {y}_{1} {k}_{2} \} , \{ {c}_{1} {m}_{2} {y}_{2} {k}_{1} \} , \{ {c}_{1} {m}_{2} {y}_{2} {k}_{2} \} ,\end{matrix} \\ \begin{matrix}\{ {c}_{2} {m}_{1} {y}_{1} {k}_{1} \} , \{ {c}_{2} {m}_{1} {y}_{1} {k}_{2} \} , \{ {c}_{2} {m}_{1} {y}_{2} {k}_{1} \} , \{ {c}_{2} {m}_{1} {y}_{2} {k}_{2} \} , \\ \{ {c}_{2} {m}_{2} {y}_{1} {k}_{1} \} , \{ {c}_{2} {m}_{2} {y}_{1} {k}_{2} \} , \{ {c}_{2} {m}_{2} {y}_{2} {k}_{1} \} , \{ {c}_{2} {m}_{2} {y}_{2} {k}_{2} \} ,\end{matrix}\end{matrix} \} ;$$

$$\vert {D}^{2} \vert = 1 + 4 ( 2 ) + 6 ( {2}^{2} ) + 4 ( {2}^{3} ) + {2}^{4} = 81$$

In essence, the cellular Neugebauer model is an m-index extrapolation of the originally described Neugebauer model, with the set D equivalent to D¹. In other words, the Neugebauer model is equivalent to the m-index cellular Neugebauer model with m=1.

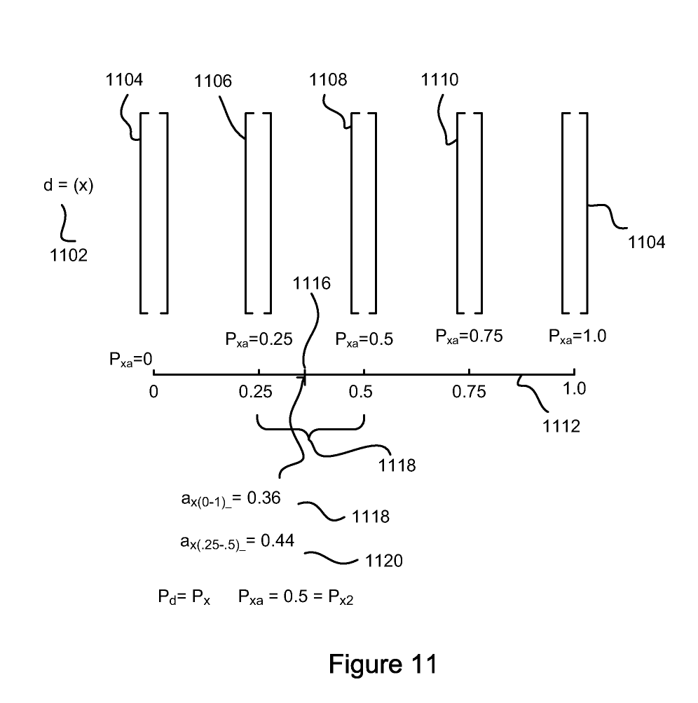

FIG. 11 illustrates, for a single dimension within an m-indexed cellular Neugebauer model, how an indexed p_{d-index} vector is chosen from among a set of related indexed p_{d-index} vectors for inclusion in the m-indexed cellular-Neugebauer-model equivalent of the basis-vector matrix P_{D} matrix, P_{D}_{^{m}}. In FIG. 11, a single-ink-color subset d of the set D 1102, is considered, where x is one of c, m, y, and k. In the Neugebauer model, there is only a single p_{X} vector corresponding to reflection of light from a sample printed with ink color x at full coverage, or a=1.0 1104. In an m=4 cellular Neugebauer model, there are, instead, four different experimentally observed spectral vectors pₓ₁, pₓ₂, pₓ₃, and p_{X4} corresponding to printing with ink color x at coverages a=0.25, a=0.5, a=0.75, and a=1.0, respectively. In addition, of course, there is the no-ink vector 1006. In FIG. 11, these vectors 1104, 1106, and 1108-1110 are arranged along an axis 1112 that is incremented with respect to coverage values of ink x. In the Neugebauer-model case, printing ink x at a coverage value of 0.36 1114 corresponds to point 1116 on the fractional-coverage axis 1112. In the Neugebauer-model case, this fractional coverage is with respect to the a=1.0 p_{X} vector 1104. However, in the m-indexed cellular Neugebauer model, where m=4, the Neugebauer-model fractional coverage 0.36 is first used to find bracketing p_{x-index} vectors 1108 and 1109, and then a fractional coverage with respect to the determined bracket 1118 is computed as the ratio

$$\frac{0.36 - 0.25}{0.25} = 0.44 ( 1120 in Figure 11 ) ,$$

or the ratio of the distance of the coverage value from the left bracketing P_{x-index} vector to the distance, in fractional coverage, between the two P_{x-index} vectors. Thus, in the one-dimensional case discussed in FIG. 11, the fractional coverage for the Neugebauer model, 0.36, is used to select one of four vectors pₓ₁, pₓ₂, pₓ₃, and p_{X4}, as well as to transform the fractional coverage with respect to the Neugebauer model into a fractional coverage with respect to a bracket within the m-indexed cellular Neugebauer model.

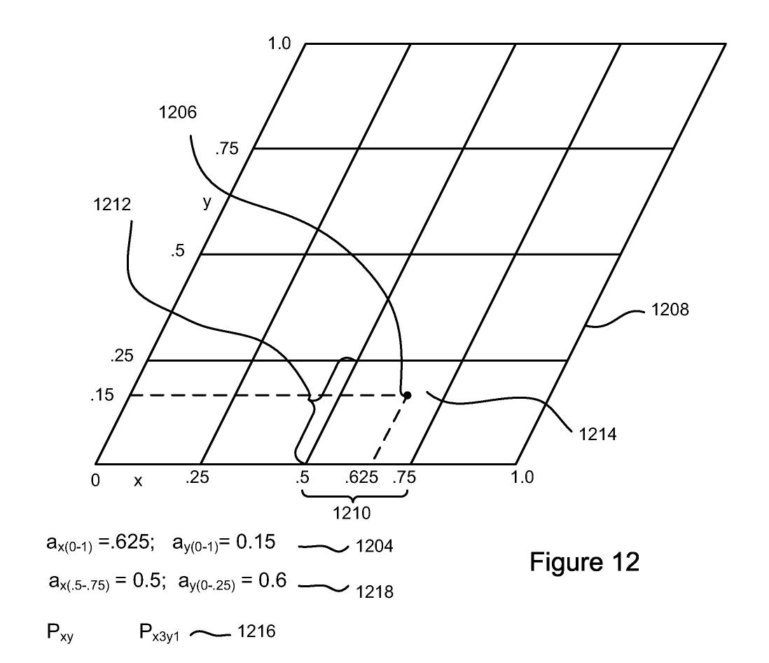

FIG. 12 illustrates, for two dimension within an m-indexed cellular Neugebauer model, how an indexed p_{d-index} vector is chosen from among a set of related indexed P_{d-index} vectors for inclusion in the m-indexed cellular-Neugebauer-model equivalent of the basis-vector matrix P_{D} matrix, P_{D}_{^{m}}. Consider a two-ink-color subset d 1202 of the set D. In the example shown in FIG. 12, the fractional coverage values are 0.625 for ink x and 0.15 for ink y 1204. As shown in FIG. 12, these two fractional coverage values specify a point 1206 in an x, y fractional-coverage plane 1208. These fractional coverage values are used to select a bracket between two experimentally observed p_{x-index} vectors in the x direction 1210 and a bracket between two experimental p_{y-index} vectors in the y dimension 1212. These two brackets define a two-dimensional cell 1214 in the x, y fractional-coverage plane 1208. Thus, the experimental vector selected for the two-ink subset in D, (x, y), where a_{X} is 0.625 and a_{y} is 0.15, is P_{x3,y1} 1216, since the x coverage value 0.625 is bracketed by the second and third coverage fractions 0.5 and 0.75, corresponding to m=2 and m=3, and the fractional coverage value 0.15 is bracketed by coverage values 0 and 0.25, corresponding to m values 0 and 1, respectively. Then, the fractional coverage values are converted to cell coverage values by determining the fractional coordinates of point 1206 with respect to the x bracket 1210 and y bracket 1212, or the edges of the cell 1214 in the x and y directions. Thus, the index coverage values are a_{X}=0.5 and a_{y}=0.6, respectively 1218. In a four-color case, the cellular Neugebauer-model cells are four-dimensional hypercubes within a four-dimensional containing volume.

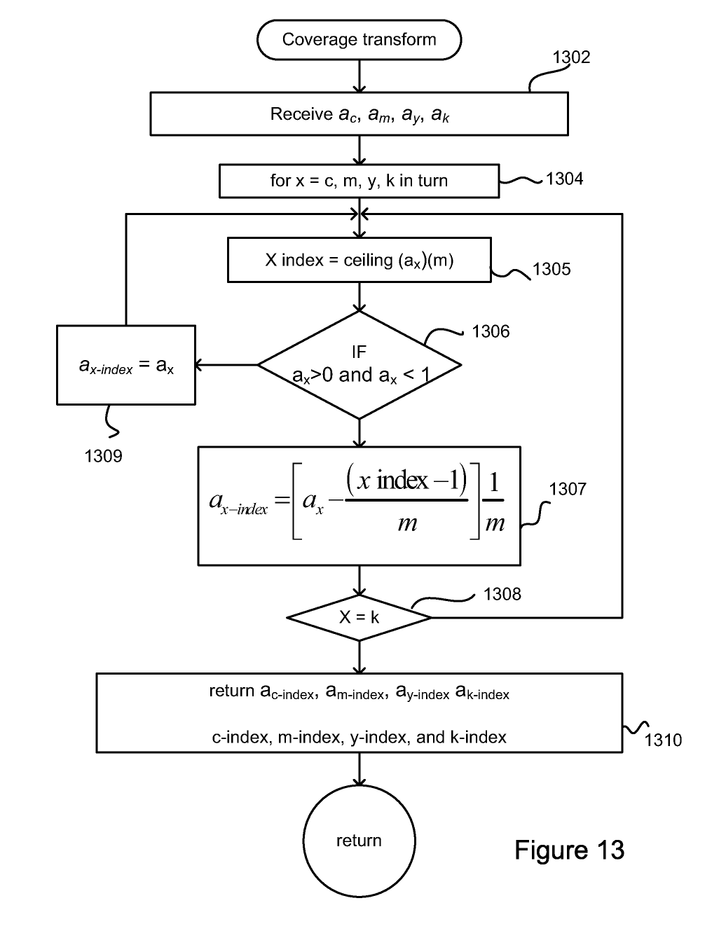

FIGS. 13-18 provide control-flow diagrams for a second embodiment of the present invention, which employs an m-indexed cellular Neugebauer model rather than the Neugebauer model employed in the initial embodiment of the present invention, illustrated in FIG. 10. The control-flow diagrams shown in FIGS. 13-18 illustrate an iterative computational method that is, due to the computational complexity of the method, necessarily carried out on an electronic computer or other electronic computational processing entity. FIG. 13 provides a flow-control diagram for a coverage-transform function that transforms Neugebauer-model fractional coverages into indexed fractional coverages with respect to cells in an m-indexed cellular Neugebauer model. In step 1302, the Neugebauer-model fractional coverage values a_{c},aₘ, a_{y}, and aₖ are received. In a for-loop comprising steps 1304-1309, each of the ink colors x, where xε{c,m,y,k}, are processed. In step 1305, the m-indexed cellular-Neugebauer-model index for ink x is computed as the ceiling of (a_{X})(m). If a_{X} is 0 or 1, as determined in step 1306, the indexed coverage value is the same as a_{X}, and is set in step 1309. Otherwise, the indexed fractional coverage a_{X-index} is computed as:

$${a}_{x - index} = [ {a}_{x} - \frac{( x index - 1 )}{m} ] \frac{1}{m}$$

The for-loop of steps 1304-1309 iterates until the loop variable x is equal to k, as determined in step 1308. In step 1310, the m-indexed fractional values a_{c-index}, a_{m-index}, a_{y-index}, and a_{k-index} are returned along with the indices for inks c, m, y, and k.

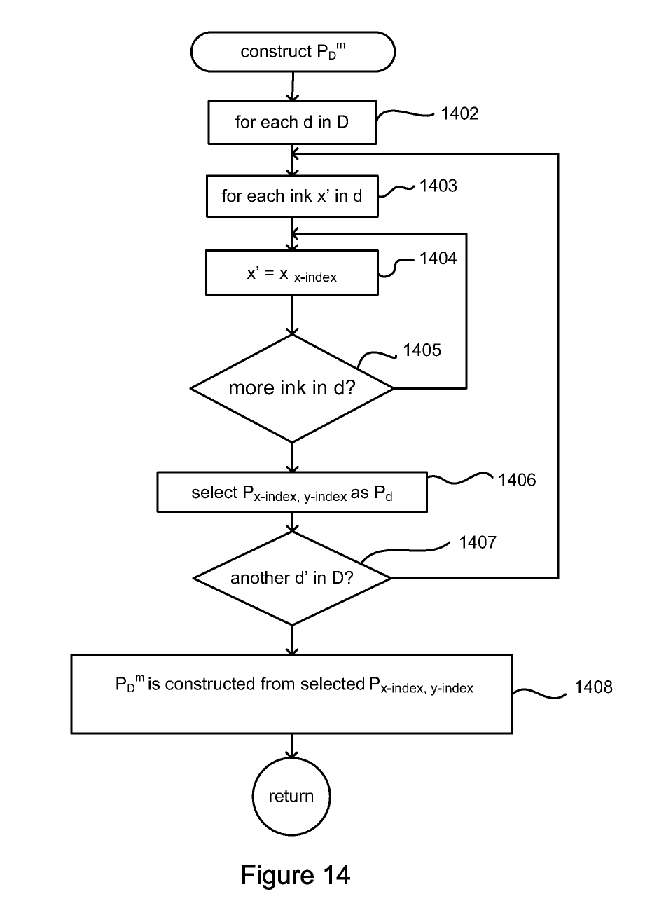

FIG. 14 provides a control-flow diagram for a routine that constructs the P_{D}_{^{m}} m-indexed cellular-Neugebauer-model basis-vector matrix equivalent to P_{D} matrix used in the Neugebauer model. In the for-loop of steps 1402-1407, each subset D in the set D is separately considered. In an inner for-loop comprising steps 1403-1405, each ink x is subscripted with the x index for the ink returned in step 1310 of FIG. 13. Then, in step 1406, the experimental vector p_{x-index,y-index} is selected as p_{d} for the current considered subset of d. Finally, in step 1408, the m-indexed cellular-Neugebauer-model matrix P_{D}_{^{m}} is constructed from the selected experimental vectors p_{x-index,y-index} computed in step 1406.

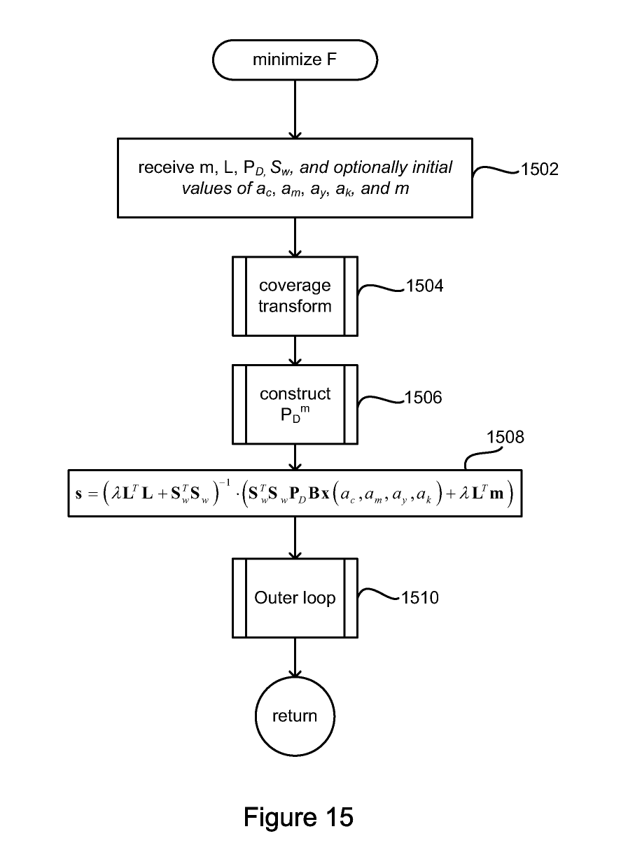

FIG. 15 provides an initial flow-control diagram for a method that minimizes the function F according to the second embodiment of the present invention. Steps 1502 and 1508 are equivalent to steps 1002 and 1004 in FIG. 10, with the exception that indexed fractional coverage values and the P_{D}_{^{m}} matrix is used rather than the P_{D} matrix. The initial Neugebauer-model fractional coverage values a_{c}, aₘ, a_{y}, and a_{X} are converted into indexed fractional values, in step 1504, by a call to the coverage-transform function illustrated in FIG. 13, and a current P_{D}_{^{m}} matrix is computed, in step 1506, by a call to the construct-P_{D}_{^{m}} function illustrated in FIG. 14. Step 1510 corresponds to the remaining steps 1006 and 1008-1015 in FIG. 10.

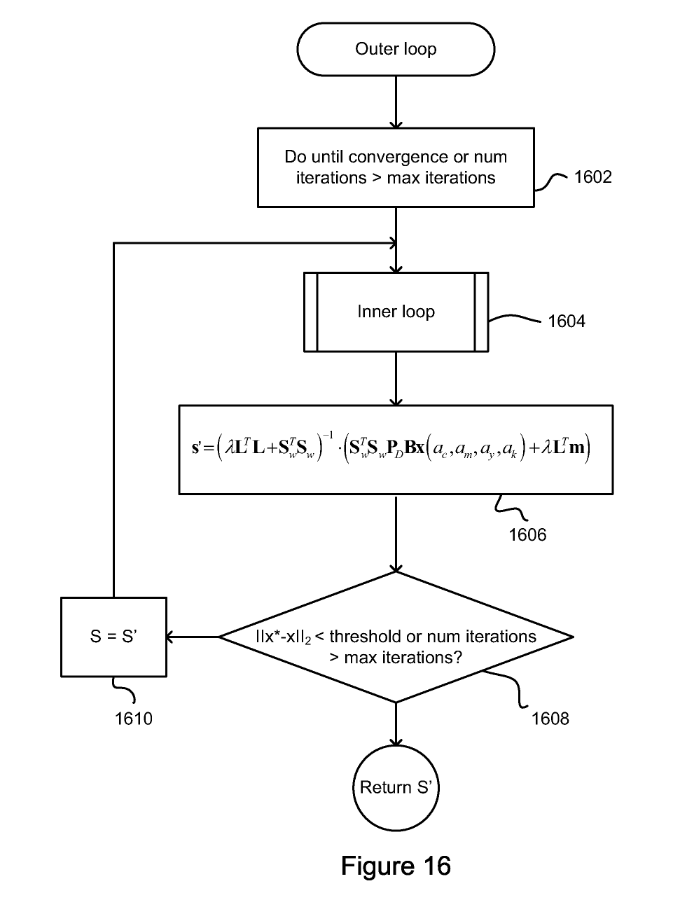

FIG. 16 provides a control-flow diagram for the routine “outer loop” called in step 1510 of FIG. 15. Step 1602 corresponds to step 1006 in FIG. 10. Step 1606 corresponds to step 1013 in FIG. 10. Step 1608 corresponds to step 1014 in FIG. 10, and step 1610 corresponds to step 1015 in FIG. 10. The call to function “inner loop” in step 1604 corresponds to steps 1008-1012 in FIG. 10. Again, indexed fractional coverages and the P_{D}_{^{m}} matrix are used, rather than the initial factional coverages and P_{D} matrix, as in the first embodiment.

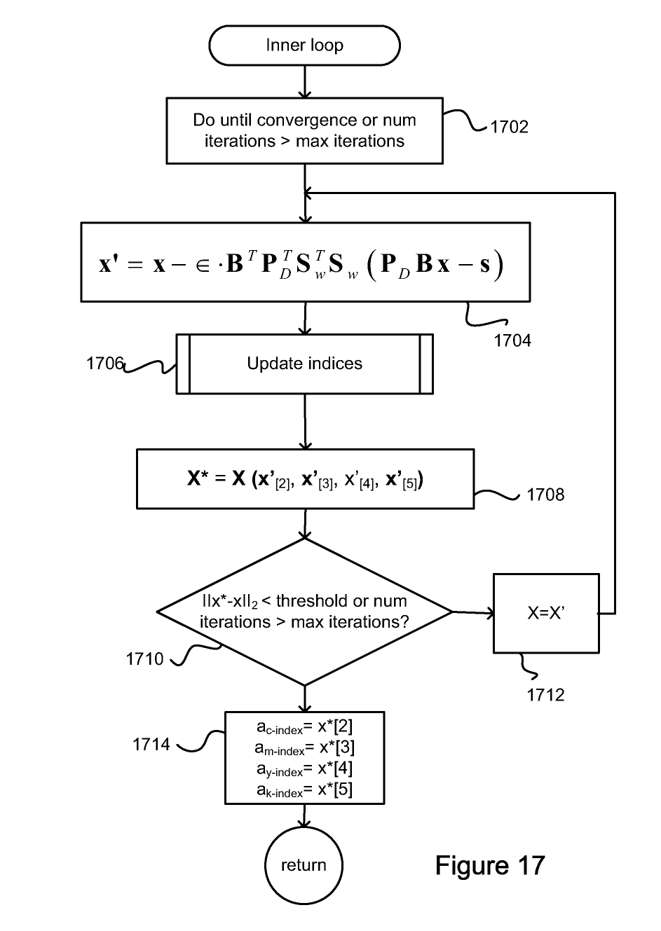

FIG. 17 provides a control-flow diagram for the routine “inner loop” called in step 1604 of FIG. 16. In steps 1704, the vector x′ is computed. The routine “update indices” is called in step 1706 to handle any changes to fractional coverages that require computation of new fractional coverages based on new m-indexed cellular-Neugebauer-model cells. In step 1708, a new vector x* is computed. Step 1710 corresponds to step 1010 in FIG. 10. Step 1712 corresponds to step 1011 in FIG. 10. Step 1714 corresponds to step 1012 in FIG. 10. Steps 1704 and 1708 together correspond to step 1009 in FIG. 10.

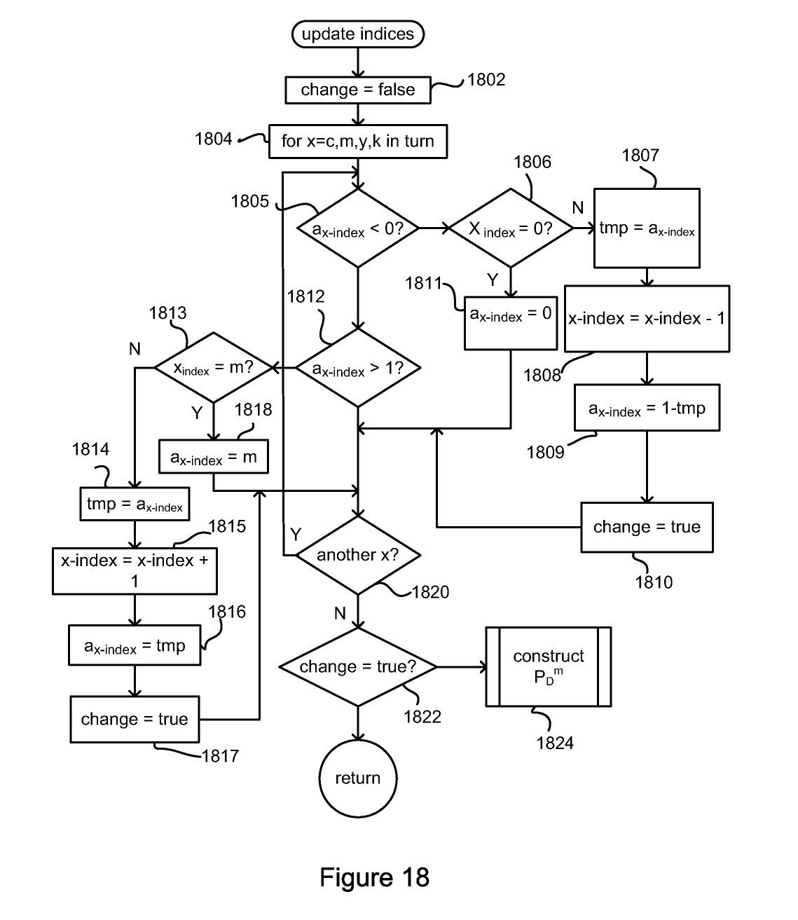

FIG. 18 provides a control-flow diagram for the routine “update indices,” called in step 1706 of FIG. 17. In step 1802, the local variable change is set to FALSE. In the for-loop of steps 1804-1818, each different ink x, where xε{c,m,y,k}, is considered. If the fractional coverage value a_{x-index} is less than 0, as determined in step 1805, then if x index is not equal to 0, as determined in step 1806, the x index is decremented, in step 1808, and the fractional coverage value for a_{x-index}, using the decremented x index, is readjusted to be one minus the fractional coverage value for the previous x index. The local variable change is set to TRUE, in step 1810, to reflect the fact that an index has changed, requiring a new P_{D}_{^{m}} matrix to be computed. Similarly, if the value of a_{x-index} is now greater than one, as determined in step 1812, then if the x index is not equal to m, as determined in step 1813, the x index is incremented, in step 1818, and the fractional-coverage value for a_{x-index}, using the incremented x index, is set to the fractional index a_{x-index}-1, using the previous x index, in step 1814. If the local variable change has been set to TRUE, as determined instep 1822, then a new P_{D}_{^{m}} matrix is constructed by a call to the construct-P_{D}_{^{m}} routine, illustrated in FIG. 14, in step 1824.

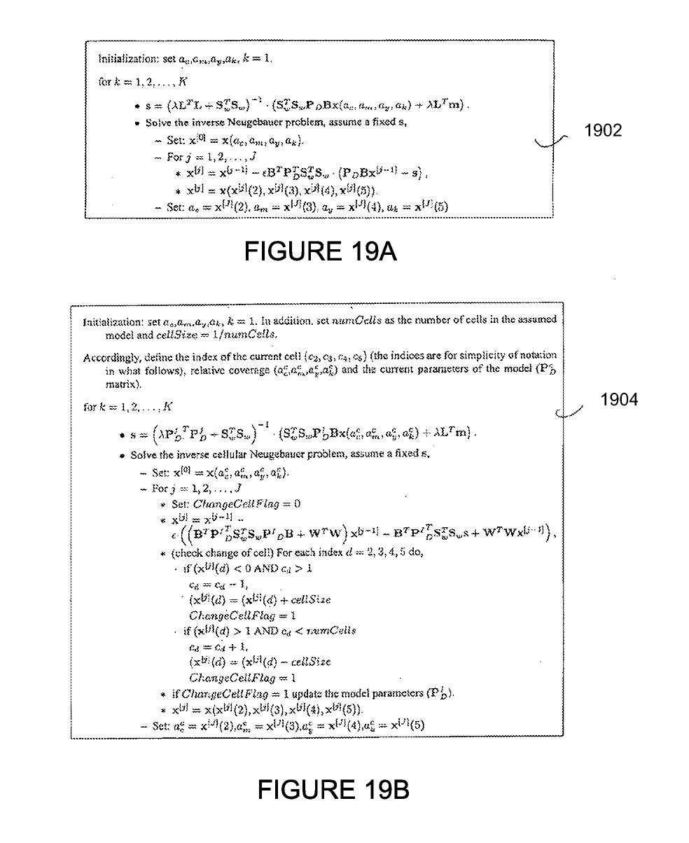

FIGS. 19A-B provide pseudocode for the first Neugebauer-model-based optimization method, discussed with reference to FIG. 10, and the m-indexed cellular-Neugebauer-model-based optimization method, discussed with reference to FIGS. 13-18, both representing embodiments of the present invention. The pseudocode 1902 and 1904 is self explanatory, and uses slightly different notational conventions for the various matrices and vectors discussed with respect to FIGS. 10 and 13-18.

As discussed above, the ink K of the CMYK four-ink printing model is not a fully independent dimension of the color model, but is instead dependent on the C, M, and Y inks. This dependency rises because a combination of C, M, and Y produces K. As a result, minimization of the function F(s,a_{c},aₘ,a_{y},aₖ) may produce a number of local minima in which the fractional coverage aₖ is increased, or decreased, from the printer-reported value aₖ⁰ by a positive or negative amount, and the printer-reported coverages a_{c}⁰, aₘ⁰, and a_{y}⁰ vary oppositely to the variation in aₖ. In other words, minimizing with respect to s and the fractional coverage values may lead to multiple solutions with equivalent or nearly equivalent spectral-vector values s and systematic variation in the fractional coverages. In order to solve this problem, the minimization function F can be expanded to incorporate an additional term to force the computed fractional-coverage values towards those reported by the printer:

$$F ( s , {a}_{c} , {a}_{m} , {a}_{y} , {a}_{k} ) = {‖ {S}_{w} ( {P}_{D} Bx ( {a}_{c} , {a}_{m} , {a}_{y} , {a}_{k} ) - s ) ‖}_{2}^{2} + μ {‖ W ( [ \begin{matrix}{a}_{c} \\ {a}_{m} \\ {a}_{y} \\ {a}_{k }\end{matrix} ] - [ \begin{matrix}{a}_{c}^{0} \\ {a}_{m}^{0} \\ {a}_{y}^{0} \\ {a}_{k}^{0}\end{matrix} ] ) ‖}_{2}^{2} + λ {‖ Ls - m ‖}_{2}^{2}$$

where W is a diagonal weight matrix that individually weights differences between the printer-reported fractional-coverages and the variable fractional coverages and the coefficient μ has a relatively low value in order to prevent interference of this additional term with the other two terms, included in the initially described function F. Inclusion of this additional term in expression for computation of the adjusted vector x′ results in the following expression:

x′=x−ε·((B^{T}P_{D}_{^{m}}^{T}S_{W}^{T}S_{W}P_{D}_{^{m}}B+W^{T}W)x−B^{T}P_{D}_{^{m}}^{T}S_{W}^{T}S_{w}s+W^{T}Wx)

Another consideration is that the filter-response matrix L is generally derived from manufacture-provided data. In many cases, the manufacture-provided data does not accurately correspond to characteristics of a particular printer and spectral-vector-determination device included within the printer. More accurate values for the filter-response matrix L can be obtained by yet another minimization problem, expressed as:

$$L = {arg min}_{L} {‖ L - {L}_{m} ‖}^{2} + λ {‖ PS - M ‖}^{2} s . t . L > 0$$

where
LεR^{3xk} are the updated filter-response profiles;
Lₘ are the filter-response profiles provided by a manufacturer;
SεR^{kxN} are spectral vectors from patch analysis; and
MεR^{3xN} are patch-analysis measurements.

Thus, the optimization procedure expressed in the above equation allows for filter-response profiles supplied by the intensity-measuring device in manufacture to be adjusted based on measurement of a number of printed patches. Additional transformation of the measured profiles can be carried out to further optimize the filter-response matrix L, including various quadratic transformations and polynomial-fitting procedures.

As discussed above, there are two original Neugebauer optimization functions. The second function, equivalent to the already-discussed minimization problem with λ equal to a large value, is:

$${min}_{s , {a}_{c} , {a}_{m} , {a}_{y} , {a}_{k}} {‖ N ( {a}_{c} , {a}_{m} , {a}_{y} , {a}_{k} ) - s ‖}_{2}^{2} s . t . Ls = m$$

A numerical solution for this optimization problem is next provided.

First, the constraint can be turned into an assignment by single-value decomposition of the matrix L:

L=UVD^{T}

where UεRₙₓₙ, VεR^{kxk} are unitary matrices and DεR^{nxk} in which all entries are zero except the (i,i) entries for all i≦n. The square part of D can be denoted as D^{r}εR^{nxn}, which is now a square diagonal matrix (assuming L has rank bigger than n). The matrix V can be divided into two parts, V=[V₁, V₂], the first part V₁ including the first n columns of V:

L=UDrV₁^{T},

Applying the constraint:

Ls=UD^{r}V₁^{T}s=m→

V₁^{T}s=(D^{r})⁻¹U^{T}m

which means that, for obeying the constraint, the n projections of s onto the n first columns of the matrix V equals (D^{r})⁻¹U^{T}m. However the values of V₂^{T}s can be arbitrary while still holding the constraint. Those values are set in order to minimize the left size of the second minimization function. Then:

$$\begin{matrix}{‖ N ( {a}_{c} , {a}_{m} , {a}_{y} , {a}_{k} ) - s ‖}_{2}^{2} = {‖ {V}^{T} ( N ( {a}_{c} , {a}_{m} , {a}_{y} , {a}_{k} ) - s ) ‖}_{2}^{2} \\ = {‖ {V}_{1}^{T} ( N ( {a}_{c} , {a}_{m} , {a}_{y} , {a}_{k} ) - s ) ‖}_{2}^{2} + \\ {V}_{2}^{T} ( N ( {a}_{c} , {a}_{m} , {a}_{y} , {a}_{k} ) - s ) {\vert \vert}_{2}^{2} \\ = {‖ {V}_{1}^{T} \cdot N ( {a}_{c} , {a}_{m} , {a}_{y} , {a}_{k} ) - {V}_{1 }^{T} s ‖}_{2}^{2} + {V}_{2}^{T} \cdot \\ N ( {a}_{c} , {a}_{m} , {a}_{y} , {a}_{k} ) - {V}_{2}^{T} s {\vert \vert}_{2}^{2}\end{matrix}$$

For minimizing the sum of two non-negative components, each one can be minimized separately. The first component can be minimized by solving:

$${min}_{{a}_{c} , {a}_{m} , {a}_{y} , {a}_{k}} {‖ {V}_{1}^{T} \cdot N ( {a}_{c} , {a}_{m} , {a}_{y} , {a}_{k} ) - {V}_{1}^{T} s ‖}_{2}^{2}$$

and afterward, the second can be set to zero by assigning:

V₂^{T}s=V₂^{T}·N(a_{c},aₘ,a_{y},aₖ).

This leaves the following minimization problem:

$${min}_{{a}_{c} , {a}_{m} , {a}_{y} , {a}_{k}} {‖ {V}_{1}^{T} \cdot {P}_{D} \cdot B \cdot x ( {a}_{c} , {a}_{m} , {a}_{y} , {a}_{k} ) - {V}_{1}^{T} s ‖}_{2}^{2}$$

An iterative approach can be used. First, the coverage values may be initialized to those supplied by the printer. Then, the following computation is iterated:

x=x(a_{c},aₘ,a_{y},aₖ)

xⁿ⁺¹=xⁿ−ε·F′ₓ(xⁿ)

[a_{c},aₘ,a_{y},aₖ]=x[2:5];

where

F(a_{c},aₘ,a_{y},aₖ)=∥V₁^{T}·P_{D}·B·x(a_{c},aₘ,a_{y},aₖ)−V₁^{T}s∥₂².

F′ₓ=B^{T}P_{D}^{T}V₁(V₁^{T}·P_{D}·B·x−V₁^{T}s).

### Experimental Results

### Neugebauer-Model-Based Method

The first, Neugebauer-model-based method for spectral-vector determination, discussed with reference to FIG. 10, was tested on spectra measured from prints of an HP Indigo™ press. FIG. 20 shows the response for three filters that are available inline on the Indigo press. First, the accuracy of spectral estimation within the same media was determined. Then, estimation of spectral vectors from a first medium was carried out after obtaining the experimentally-observed spectral vectors that together compose the P_{D} matrix from a second medium. The projections of all tested spectra were calculated digitally in order to avoid measurement noise.

Two different tests were conducted at two different times. In each test, a full grid of 5⁴=625 patches (jumps of 25% in the coverage of each separation) were printed on three different types of papers. Different types of papers were used for two main reasons: first, to test the behavior on different media, and second, to estimate generalization capabilities from one media to another. All patches were numerically projected on the three filter profiles shown in FIG. 20. The spectrum estimation was done using these three projections, following the numerical scheme of the above-described Neugebauer-model-based method

In each test, three sets of spectra were considered for the Neugebauer parameters P_{D}. The three sets where measured from corresponding patches of the three printed papers. All patches were tested assuming each of the three sets of spectra (three types of papers, each examined with three types of parameter sets, results in nine sets of results in each test). The mean ΔE values and 95% errors of the two tests are reported in Tables 1 and 2, respectively. As expected, the results on the diagonal (spectrum estimation where the model is taken from the same type of paper) are substantially better than the off-diagonal results. A better match between the Coated and Un-Coated white papers compared to the match with the yellow or blue papers can also be seen in these results. Moreover, notice that, assuming a white paper parameter set, in estimation of a colored medium, produces much better results than assuming a color paper parameter set and estimating a spectrum on a white paper. This is understandable, as the color pigments in the colored papers can be considered as additional ink coverage, while the counter case of less ink coverage is impossible.

TABLE 1
Test 1 results: the mean error and 95% error in estimating the spectra of
625 patches on three different types of paper, assuming three different sets
of spectra for the Neugebauer model.

| | White coated | White uncoated | Yellowish paper |
|---|---|---|---|
| ΔE₂₀₀₀/95% result | paper model | paper model | model |
| White coated | 0.36/0.59 | 0.41/0.93 | 1.59/3.89 |
| White uncoated | 0.56/0.98 | 0.34//0.66 | 1.25/2.83 |
| Yellowish | 0.98/1.75 | 1.02/1.84 | 0.29/0.59 |

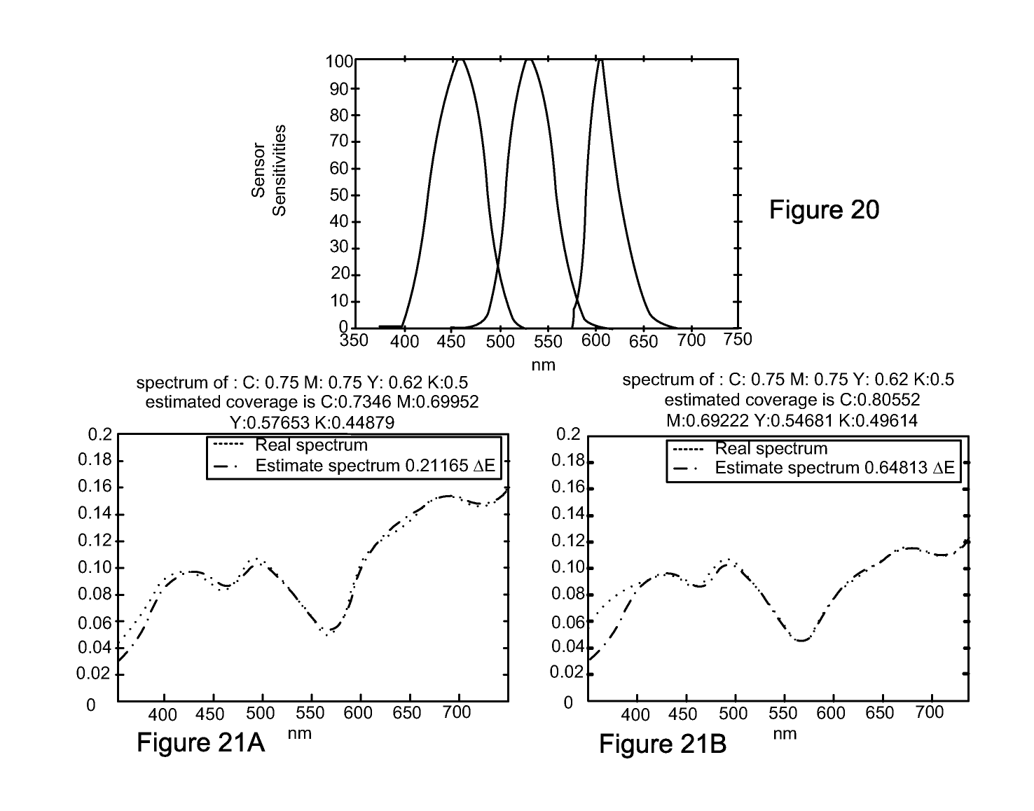

FIGS. 21A-B provide results from the test analysis according to an embodiment of the present invention. FIG. 21A presents an estimation of the spectral reflectance printed on a coated paper with model parameters taken from the coated paper while FIG. 21B presents an estimation of the spectral reflectance printed on an uncoated paper with the coated paper model parameters.

TABLE 2
Test 2 results: the mean error and 95% error in estimating the spectra of
625 patches on three different types of paper, assuming three different
sets of spectra for the Neugebauer model.

| | White paper | | Yellow paper |
|---|---|---|---|
| ΔE₂₀₀₀/95% result | model | Blue paper model | model |
| White paper | 0.27/0.53 | 1.01/2.76 | 0.89/2.62 |
| Blue paper | 0.50/1.07 | 0.33/0.72 | 0.834/2.16 |
| Yellow paper | 0.76/1.68 | 1.04/2.36 | 0.28/0.64 |

The m-Indexed Cellular-Neugebauer-Model-Based Method

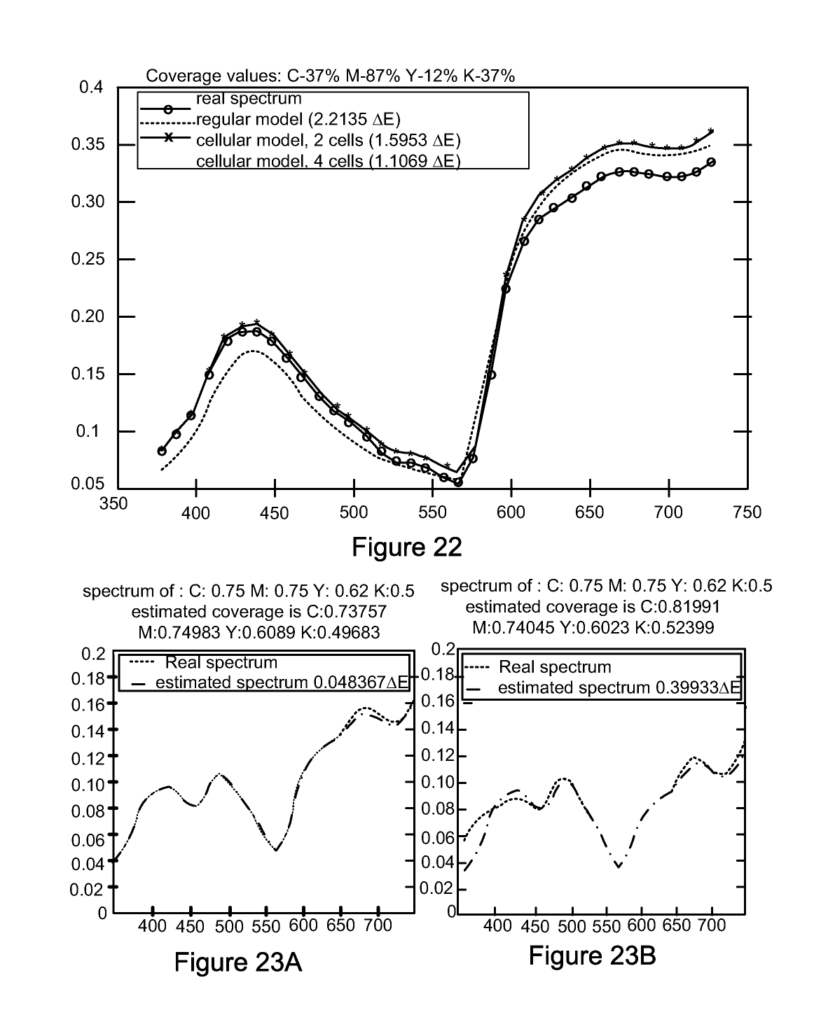

Two tests similar to the test described in the previous subsection were carried out and recalculated with the cellular model. FIG. 22 shows improved accuracy obtained by the m-indexed cellular-Neugebauer-model-based method according to an embodiment of the present invention. FIGS. 23A-B provide results from the m-indexed cellular-Neugebauer-model-based method, according to an embodiment of the present invention, in similar fashion to FIGS. 21A-B. Tables 3 and 4 present results from the m-indexed cellular-Neugebauer-model-based method similar to those presented in Tables 1 and 2. Notice the vast improvement in all results compared to the results of m-indexed Neugebauer-model-based method, shown in Tables 1 and 2. This improvement is due to the improved accuracy provided by the m-indexed Neugebauer-model-based method.

TABLE 3
Test 3 results: the mean error and 95% error in estimating the spectra of
625 patches on three different types of paper, assuming three different
types of models for the cellular Neugebauer model.

| | | White uncoated | |
|---|---|---|---|
| ΔE₂₀₀₀/95% | White coated | paper | Yellowish paper |
| result | paper model | model | model |
| White coated | 0.13/0.33 | 0.29/0.75 | 1.59/3.93 |
| White uncoated | 0.33/0.67 | 0.14//0.36 | 1.08/2.55 |
| Yellowish | 0.81/1.60 | 0.63/1.34 | 0.12/0.32 |

TABLE 4
Test 4 results: the mean error and 95% error in estimating the spectra
of 625 patches on three different types of paper, assuming three different
types of models for the cellular Neugebauer model.

| ΔE₂₀₀₀/95% | | | |
|---|---|---|---|
| result | White model | Blue model | Yellow model |
| white paper | 0.11/0.31 | 0.89/2.93 | 0.80/2.23 |
| blue paper | 0.77/2.44 | 0.13/0.39 | 1.04/2.83 |
| yellow paper | 0.71/1.99 | 0.99/2.76 | 0.12/0.32 |

Although the present invention has been described in terms of particular embodiments, it is not intended that the invention be limited to these embodiments. Modifications will be apparent to those skilled in the art. For example, as discussed above, embodiments of the present invention can be employed in a wide variety of different types of spectral-vector-determination devices and analysis components of such devices, these devices, in turn, incorporated into a wide variety of different types of electronic systems, from color printers to medical-diagnostic equipment, quality-control-monitoring devices, and a wide variety of other systems and devices. Spectral-vector determination methods of the present invention may be implemented in a wide variety of different programming languages in many different ways by varying common implementation parameters, including control structures, data structures, modular organization, and other such implementation parameters. In the above discussion, the cellular Neugebauer model is assumed to employ a common m for all of the ink dimensions. However, in alternative embodiments of the present invention, each color dimension may have a different number of p_{d-index} experimentally-determined spectral vectors, and thus the Neugebauer cells may be hyperdimensional rectangular prisms rather than hypercubes. Furthermore, spectral-vector estimation may be carried out by additional methods according to models other than the Neugebauer model or the m-indexed cellular Neugebauer model. Embodiments of the present invention may be extended to accommodate other color-printing systems, including those that use six different colored inks and other numbers of colored inks. In such cases, the functions minimized may be written as:

$$F ( s , {a}_{x 1} , {a}_{x 2} , {a}_{x 3} , … , {a}_{xr} ) = {‖ {S}_{w} ( {P}_{D} Bx ( {a}_{x 1} , {a}_{x 2} , {a}_{x 3} , … , {a}_{xr} ) - s ) ‖}_{2}^{2} + λ {‖ Ls - m ‖}_{2}^{2}$$

$$F ( s , {a}_{x 1} , {a}_{x 2} , {a}_{x 3} , … , {a}_{x r} ) = {‖ {S}_{w} ( N ( {a}_{x 1} , {a}_{x 2} , {a}_{x 3} , … , {a}_{xr} ) - s ) ‖}_{2}^{2} s . t . Ls = m$$

$$F ( s , {a}_{x 1} , {a}_{x 2} , {a}_{x 3} , … , {a}_{x r} ) = {‖ {S}_{w} ( {P}_{D} Bx ( {a}_{x 1} , {a}_{x 2} , {a}_{x 3} , … , {a}_{x r} ) - s ) ‖}_{2}^{2} + μ {‖ W ( [ \begin{matrix}{a}_{x 1} \\ {a}_{x 2} \\ {a}_{x 3} \\ ⋮ \\ {a}_{x r}\end{matrix} ] - [ \begin{matrix}{a}_{x 1}^{0} \\ {a}_{x 2}^{0} \\ {a}_{x 3}^{0} \\ ⋮ \\ {a}_{xr}^{0}\end{matrix} ] ) ‖}_{2}^{2} + λ {‖ Ls - m ‖}_{2}^{2}$$

Embodiments of the present invention may also be extended to many other systems in which sample interaction with electromagnetic radiation is constrained, so that the expected spectral vectors fall onto a manifold or hyperdimensional surface within R^{k}, where k is the dimension of the desired spectral vector. The dimension of the determined spectral vector, k, may also be altered so that the method embodiments of the present invention can be applied, given the physical and chemical constraints of the problem domain.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. A system that determines a k-dimensional spectral vector s for electromagnetic radiation reflected from, transmitted through, or emitted by a sample, the system comprising:
a detector that measures electromagnetic-radiation intensity through a number n of different filters to produce n intensity measurements, where n is less than k; and
an analysis component that uses filter-response functions and the n intensity measurements to determine the k-dimensional spectral vector for the electromagnetic radiation, the analysis component employing a spectral-vector estimation function to generate an estimated spectral vector sₑ from a number of independent sample parameters and minimizing a metric based on a difference between the estimated spectral vector sₑ and the determined spectral vector s.

2. The system of claim 1 incorporated, as a subsystem, into an electronic system.

3. The system of claim 2 wherein the electronic system is one of:
a printer;
a diagnostic-analysis system;
a chemical-analysis system;
a surface-analysis system;
an optical system, including an automated telescope, camera, video recorder, and other optical systems;
a quality-control-monitoring system; and
an environmental monitoring system.

4. The system of claim 1 including embodying the metric in a function F that is minimized over s and one or more of the number of independent sample parameters.

5. The system of claim 4 where the function F that is minimized over s and one or more of the number of independent sample parameters includes, as one term, the metric based on a difference between the estimated spectral vector sₑ and the determined spectral vector s and further includes one or more additional terms or constraints.

6. The system of claim 5 included as a subsystem within a color printer that prints a patch using up to r different inks
wherein aₓₙ is the coverage for ink xn in the patch;
wherein the estimated spectral vector sₑ is generated by a spectral-vector-estimation function N(a₁, a₂, . . . , aᵣ);
wherein the n intensity measurements are included as components in an n-dimensional vector m;
wherein a matrix L includes n rows, each row representing a filter-response vector for one of the filters;
wherein a matrix S_{w} is a diagonal weight matrix of dimension k×k;
wherein ∥S_{w}(N(aₓ₁,aₓ₂,aₓ₃, . . . ,aₓᵣ)−s)∥₂² is the metric based on a difference between the estimated spectral vector sₑ and the determined spectral vector s;
wherein Ls=m is a constraint; and
wherein the function F that is minimized is:
F(s,aₓ₁,aₓ₂;aₓ₃; . . . ;aₓᵣ)=∥S_{w}(N(aₓ₁,aₓ₂;aₓ₃; . . . ;aₓᵣ)−s)∥₂²s.t.LS=m.

7. The system of claim 5 included as a subsystem within a color printer that prints a patch using up to r different inks
wherein λ is a constant;
wherein a_{X} is the coverage for ink x in the patch;
wherein the estimated spectral vector sₑ is generated by a function N(a₁, a₂, . . . , aᵣ);
wherein the n intensity measurements are included as components in an n-dimensional vector m;
wherein a matrix L includes n rows, each row representing a filter-response vector for one of the filters;
wherein matrices P_{D} contains, as columns, experimentally-observed spectral vectors for patches printed with different ink combinations at known coverages;
wherein a matrix B includes components having values 0, −1, and 1;
wherein a matrix S_{W} is a diagonal weight matrix of dimension k×k;
wherein the function x(a₁, a_{z}, . . . , aᵣ) returns a vector of terms that include “1,” ink-coverage values, and products of ink-coverage values;
wherein P_{D}B x(a₁, a₂, . . . , aᵣ) is equivalent to N(a₁, a_{z}, . . . , aᵣ);
wherein ∥S_{w}(P_{D}Bx(aₓ₁,aₓ₂,aₓ₃, . . . ,aₓᵣ)−s)∥₂² is the metric based on a difference between the estimated spectral vector sₑ and the determined spectral vector s;
wherein λ∥Ls−m∥₂² is an additional term; and
wherein the function F that is minimized is:
F(s,aₓ₁,aₓ₂,aₓ₃, . . . ,aₓᵣ)=∥S_{w}(s,aₓ₁,aₓ₂,aₓ₃, . . . ,aₓᵣ)−s)∥₂²+λ∥Ls−m∥₂².

8. The system of claim 5 included as a subsystem within a color printer that prints a patch using up to r different inks
wherein μ is a constant;
wherein W is a diagonal weight matrix;
wherein λ is a constant;
wherein a_{X} is the coverage for ink x in the patch;
wherein the estimated spectral vector sₑ is generated by a function N(a₁, a_{z}, . . . , aᵣ);
wherein the n intensity measurements are included as components in an n-dimensional vector m;
wherein a matrix L includes n rows, each row representing a filter-response vector for one of the filters;
wherein matrices P_{D} contains, as columns, experimentally-observed spectral vectors for patches printed with different ink combinations at known coverages;
wherein a matrix B includes components having values 0, −1, and 1;
wherein a matrix S, is a diagonal weight matrix of dimension k×k;
wherein the function x(a₁, a_{z}, . . . , aᵣ) returns a vector of terms that include “1,” ink-coverage values, and products of ink-coverage values;
wherein P_{D}B x(a₁, a₂, . . . , aᵣ) is equivalent to N(a₁, a₂, . . . , aᵣ);
wherein ∥S_{w}(P_{D}Bx(aₓ₁,aₓ₂,aₓ₃, . . . ,aₓᵣ)−s)∥₂² is the metric based on a difference between the estimated spectral vector sₑ and the determined spectral vector s;
wherein λ∥Ls−m∥₂² is a first additional term;
wherein
$$μ {‖ W ( [ \begin{matrix}{a}_{x 1} \\ {a}_{x 2} \\ {a}_{x 3} \\ ⋮ \\ {a}_{x r}\end{matrix} ] - [ \begin{matrix}{a}_{x 1}^{0} \\ {a}_{x 2}^{0} \\ {a}_{x 3}^{0} \\ ⋮ \\ {a}_{xr}^{0}\end{matrix} ] ) ‖}_{2}^{2}$$
is a second additional term; and
wherein the function F that is minimized is:
$$F ( s , {a}_{x 1} , {a}_{x 2} , {a}_{x 3} , … , {a}_{xr} ) = {‖ {S}_{w} ( {P}_{D} Bx ( {a}_{x 1} , {a}_{x 2} , {a}_{x 3} , … , {a}_{x r} ) - s ) ‖}_{2}^{2} + μ {‖ W ( [ \begin{matrix}{a}_{x 1} \\ {a}_{x 2} \\ {a}_{x 3} \\ ⋮ \\ {a}_{x r}\end{matrix} ] - [ \begin{matrix}{a}_{x 1}^{0} \\ {a}_{x 2}^{0} \\ {a}_{x 3}^{0} \\ ⋮ \\ {a}_{xr}^{0}\end{matrix} ] ) ‖}_{2}^{2} + λ {‖ Ls - m ‖}_{2}^{2} .$$

9. The system of claim 5 included as a subsystem within a color printer that prints a patch using up to r different inks
wherein a_{X} is the coverage for ink x in the patch, expressed as cell-relative fractions;
wherein the estimated spectral vector sₑ is generated by a function N(a_{x1-x1index},a_{x2-x2index};a_{x3-x13index}; . . . ;a_{xr-xrindex});
wherein the n intensity measurements are included as components in an n-dimensional vector m;
wherein a matrix L includes n rows, each row representing a filter-response vector for one of the filters;
herein a matrix S, is a diagonal weight matrix of dimension k×k;
wherein ∥S_{w}(N(a_{x1-x1index},a_{x2-x2index};a_{x3-x13index}; . . . ;a_{xr-xrindex})−s)∥₂² is the metric based on a difference between the estimated spectral vector sₑ and the determined spectral vector s;
wherein Ls=m is a constraint; and
wherein the function F that is minimized is:
F(s,a_{x1-x1index},a_{x2-x2index};a_{x3-x13index}; . . . ;a_{xr-xrindex})=∥S_{w}(N(a_{x1-x1index},a_{x2-x2index};a_{x3-x13index}; . . . ;a_{xr-xrindex})−s)∥₂²s.t.LS=m.

10. The system of claim 5 included as a subsystem within a color printer that prints a patch using up to r different inks
wherein λ is a constant;
wherein a_{X} is the coverage for ink x in the patch, expressed as cell-relative fractions;
wherein the estimated spectral vector sₑ is generated by a function N(a₁, a₂, . . . , aᵣ);
wherein the n intensity measurements are included as components in an n-dimensional vector m;
wherein a matrix L includes n rows, each row representing a filter-response vector for one of the filters;
wherein matrices P_{D}_{^{m}} contains, as columns, experimentally-observed spectral vectors for patches printed with different ink combinations at known coverages;
wherein a matrix B includes components having values 0, −1, and 1;
wherein a matrix S, is a diagonal weight matrix of dimension k×k;
wherein the function x(a₁, a₂, . . . , aᵣ) returns a vector of terms that include “1,” ink-coverage values, and products of ink-coverage values;
wherein P_{D}B x(a₁, a₂, . . . , aᵣ) is equivalent to N(a₁, a₂, . . . , aᵣ); and
wherein ∥S_{w}(P_{D}_{^{m}}Bx(aₓ₁,aₓ₂,aₓ₃, . . . ,aₓᵣ)−s)∥₂² is the metric based on a difference between the estimated spectral vector sₑ and the determined spectral vector s;
wherein λ∥Ls−m∥₂² is an additional term; and
wherein the function F that is minimized is:
F(s,a_{x1-x1index},a_{x2-x2index};a_{x3-x13index}; . . . ;a_{xr-xrindex})=∥S_{w}(P_{D}_{^{m}}Bx(a_{x1-x1index},a_{x2-x2index};a_{x3-x13index}; . . . ;a_{xr-xrindex})−s)∥₂²+λ∥LS−m∥₂².

11. The system of claim 5 included as a subsystem within a color printer that prints a patch using up to r different inks
wherein μ is a constant;
wherein W is a diagonal weight matrix;
wherein λ is a constant;
wherein a_{X} is the coverage for ink x in the patch, expressed as cell-relative fractions;
wherein the estimated spectral vector sₑ is generated by a function N(a₁, a₂, . . . , aᵣ);
wherein the n intensity measurements are included as components in an n-dimensional vector m;
wherein a matrix L includes n rows, each row representing a filter-response vector for one of the filters;
wherein matrices P_{D}_{^{m}} contains, as columns, experimentally-observed spectral vectors for patches printed with different ink combinations at known coverages;
wherein a matrix B includes components having values 0, −1, and 1;
wherein a matrix S_{w} is a diagonal weight matrix of dimension k×k;
wherein the function x(a₁, a₂, . . . , aᵣ) returns a vector of terms that include “1,” ink-coverage values, and products of ink-coverage values;
wherein P_{D}B x(a₁, a₂, . . . , aᵣ) is equivalent to N(a₁, a₂, . . . , aᵣ);
wherein ∥S_{w}(P_{D}Bx(aₓ₁,aₓ₂,aₓ₃, . . . ,aₓᵣ)−s)∥₂² is the metric based on a difference between the estimated spectral vector sₑ and the determined spectral vector s;
wherein λ∥Ls−m∥₂² is a first additional term;
wherein
$$μ {‖ W ( [ \begin{matrix}{a}_{x 1 - x 1 index} \\ {a}_{x 2 - x 2 index} \\ {a}_{x 3 - x 13 index} \\ ⋮ \\ {a}_{x r - xr index}\end{matrix} ] - [ \begin{matrix}{a}_{x 1 - x 1 index}^{0} \\ {a}_{x 2 - x 2 index}^{0} \\ {a}_{x 3 - x 13 index}^{0} \\ ⋮ \\ {a}_{xr - xrindex}^{0}\end{matrix} ] ) ‖}_{2}^{2}$$
is a second additional term; and
wherein the function F that is minimized is:
$$F ( s , {a}_{x 1 - x 1 index} , {a}_{x 2 - x 2 index} , {a}_{x 3 - x 13 index} , … , {a}_{xr - xr index} ) = {‖ {S}_{w} ( {P}_{{D}^{m}} Bx ( {a}_{x 1 - x 1 index} , {a}_{x 2 - x 2 index} , {a}_{x 3 - x 13 index } , … , {a}_{xr - xrindex} ) - s ) ‖}_{2}^{2} + μ {‖ W ( [ \begin{matrix}{a}_{x 1 - x 1 index} \\ {a}_{x 2 - x 2 index} \\ {a}_{x 3 - x 13 index} \\ ⋮ \\ {a}_{x r - xr index}\end{matrix} ] - [ \begin{matrix}{a}_{x 1 - x 1 index}^{0} \\ {a}_{x 2 - x 2 index}^{0} \\ {a}_{x 3 - x 13 index}^{0} \\ ⋮ \\ {a}_{xr - xrindex}^{0}\end{matrix} ] ) ‖}_{2}^{2} + λ {‖ Ls - m ‖}_{2}^{2} .$$

12. The system of claim 5 wherein the function F is minimized iteratively, in each iteration computing a new value for the determined spectral vector s followed by computing new values for the one or more of the sample parameters.

13. A method for determining a k-dimensional spectral vector s for electromagnetic radiation reflected from, transmitted through, or emitted by a sample, the method comprising:
receiving a number n of intensity measurements, where n is less than k, from a detector that measures electromagnetic-radiation intensity through n different filters; and
using filter-response vectors observed for known samples and the n intensity measurements to determine the k-dimensional spectral vector for the electromagnetic radiation, in processing steps carried out by an electronic computer or other electronic computing device, by employing a spectral-vector estimation function to generate an estimated spectral vector sₑ from a number of independent sample parameters and minimizing a metric based on a difference between the estimated spectral vector sₑ and the determined spectral vector s.

14. The method of claim 13 further including embodying the metric in a function F that is minimized over s and one or more of the number of independent sample parameters.

15. The method of claim 16 further including minimizing the function F over s and one or more of the number of independent sample parameters includes, as one term, the metric based on a difference between the estimated spectral vector sₑ and the determined spectral vector s and further includes one or more additional terms or constraints, wherein the function F is minimized iteratively, in each iteration computing a new value for the determined spectral vector s followed by computing new values for the one or more of the sample parameters.
